(19) United States
(12) Patent Application Publication
(10) Pub. No.: US 2014/0140069 A1
(43) Pub. Date: May 22, 2014

(54) LED ILLUMINATION ASSEMBLIES INCLUDING PARTIAL LENSES AND METAL REFLECTORS

(71) Applicant: Philip Premysler, Washington, DC (US)

(72) Inventor: Philip Premysler, Washington, DC (US)

(21) Appl. No.: 13/849,528

(22) Filed: Mar. 24, 2013

Related U.S. Application Data
(63) Continuation-in-part of application No. 13/060,476, filed on Feb. 24, 2011, now Pat. No. 8,405,920.

(51) Int. Cl. F21K 99/00; F21S 8/08

(52) U.S. Cl. CPC F21K 9/50; F21S 8/085
USPC 362/308; 362/296.01

(57) ABSTRACT

An illumination assembly includes a planar or piecewise planar metal reflector positioned very close to an LED subtending a first azimuthal angle range Θ1 that is less than 360° about the LED and a partial lens positioned close to the LED and subtending a second azimuthal angle range (e.g., Θ2=360°−Θ1) less than 360° about the LED. The metal reflector forming one or more images of the LED that are close to the LED, thereby limiting optical source size growth and reflecting light into the partial lens.

### RELATED APPLICATION DATA

This patent application is a continuation-in-part of co-pending Ser. No. 13/060,476 filed Feb. 24, 2011.

### FIELD OF THE INVENTION

The present invention relates to illumination optics especially suitable for use with Light Emitting Diodes.

### BACKGROUND OF THE INVENTION

Traditionally Light Emitting Diodes (LEDs) have primarily been used as indicator lamps in electronic equipment. However recently the power and efficacy (e.g., lumens per watt of electrical power) has been increasing and LEDs have been identified as a possible replacement for inefficient incandescent lamps in certain applications. The light emitting region of an LED is small (e.g., in the range of 2 mm to 0.7 mm across in many cases) which in theory opens up the possibility for highly controlled distribution of light. However many of LED optics developed so far do not produce controlled distributions, rather they typically produce Gaussian like distributions which is the hallmark of somewhat uncontrolled (random) light distribution, and is not ideal for most, if not all applications.

A bare LED chip or an LED chip covered in an encapsulating protective transparent hemisphere, emits light over an entire hemisphere of solid angle, albeit with diminishing intensity at polar angles (zenith angles) approaching π/2. FIG. 1 is a plot light intensity in arbitrary units as a function of polar angle for a commercial high power LED.

FIG. 2 shows a reflector 202 arranged to collect a portion of light emitted by an LED 204. A problem with using a reflector with an LED that emits over the entire hemisphere of solid angle is that the reflector needs to have an aperture and thus cannot intercept and redirect all of the light. As shown in FIG. 1 light emitted within polar angle range from zero to φ passes through the aperture of the reflector 202 without redirection or control. Additionally for the reflector 202 to exert detailed control over the emitted light distribution it must be specular as opposed to diffuse, and polishing a reflector sufficiently to make it specular is often expensive.

In an attempt to address the problem posed by the hemispherical range of light output from LED, a type of “primary” optic 302 shown in FIG. 3 has been developed. (This is termed a “primary” optic because it is assumed that it may be used in conjunction with a “secondary” optic such as the reflector 202.) The term “primary optic” may also be taken to mean an optic which has an optical medium of index>1 extending from the LED die so that there are only outer optical surfaces. The primary optic 302 is designed to intercept light emitted by an LED chip which is positioned in a space 304 at the bottom of the primary optic 302 and to redirect the light radially outward, perpendicular to an optical axis 306. The primary optic includes a refracting part 308 and a TIR (Total Internal Reflection) part 310 both of which contribute to redirecting the light. One drawback of the primary optic 302 is that because it includes multiple optical surfaces that contribute to light in the same direction it will increase the effective size of the source (also the étendue), which reduces the controllability of light from the LED. The increased effective size of the source can in some cases be compensated for, by using larger secondary optics but this may be undesirable based on cost and space constraints. By way of loose analogy to imaging optics, the primary optic creates multiple “images” of the LED, e.g., one from the refracting part 308 and one from the TIR part 310.

Although, the primary optic 302 is intended to redirect light perpendicular to the optical axis, in practice light is redirected to a range of angles. This is because the primary optic is small and positioned in close proximity to the LED, and consequently the LED subtends a not-insignificant solid angle from each point of the primary optic, and light received within this finite solid angle is refracted or reflected into a commensurate solid angle. The result is shown in FIG. 4 which is a plot of light intensity vs. polar angle for an LED equipped with the primary optic 302. Although this distribution of light shown in FIG. 4 is not especially suited to any particular application, it is intended to direct light into an angular range that can be intercepted by a secondary optic e.g., reflector 202. The goal is not fully achieved in that the angular distribution of light produced by the primary optic 302 covers a range that extends from zero polar angle and therefore all of the light cannot be intercepted by the reflector 202.

Another presently manufactured commercial optic 502 for LEDs is shown in FIG. 5. In use, an LED (not shown) will be located in a bottom recess 504. This optic 502 is one form of “secondary” optic. A LED with or without the primary optic 302 attached can be used. If used the primary optic will fit inside the bottom recess 504. The secondary optic 502 is made from optical grade acrylic (PMMA) and is completely transparent with no reflective coatings. The optic 502 includes a TIR (Total Internal Reflection) parabolic surface 506 which collects a first portion of light emitted by the LED, and a convex lens surface 508 which collects a remaining portion of the light. Both surfaces 506, 508 are intended to collimate light. As might be expected in actuality the light is distributed in a Gaussian-like angular distribution over a certain angular range which is variously reported as 5 degrees and 10 degrees. The former value may be a FWHM value, and the actual value will vary depending on the exact LED that is used. This design is only useful for a fairly narrow range of specialized applications that require a far-field highly collimated LED spotlight. FIG. 6 shows an angular distribution of light produced by this type of optic. As shown the angular distribution is Gaussian-like not uniform.

In order to get a broader angular distribution of light some form of surface relief pattern can be added to a top surface 510 of the optic 502 which is planar as shown in FIG. 5. Alternatively, the surface relief pattern can be formed on a “tertiary” optic that is attached to the top surface 510. One type of surface relief pattern-concentric rings of convolutions is shown in a plan view in FIG. 7 and in a broken-out sectional elevation view in FIG. 8. Another type of surface relief pattern-an array of lenslets is shown in a plan view in FIG. 9 and in a broken-out sectional elevation view in FIG. 10. FIGS. 11 and 12 show light intensity distributions produced by commercial optics that have the same general design as shown in FIG. 5 but which have top surfaces with a surface relief pattern to broaden the angular distribution. The distribution shown in FIG. 11 is designated as having a 15 degree half-angle pattern and that shown in FIG. 12 a 25 degree half angle pattern.

In fact at 25 degrees such designs are coming up against a limit. The limitation is explained as follows. Given that the optic 502 with a flat surface 510 nearly collimates light to within a nominal 5 degree half angle, it can be inferred that light is incident at the surface 510 at about 5/n degrees, where n is the index of refraction of the optic, which for the sake of the following can be considered zero i.e., collimated. In order to create broader distributions of light, some relief pattern as discussed above is added to the top surface 510. Portions of the relief pattern will be tilted relative to the light rays incident from below, and will therefore refract light out at larger angles than would the flat top surface 510. However, at about 25 degrees, depending on how much light loss will be tolerated a limited is reached-in particular the transmittance of the surface starts to decline rapidly. In this connection it is to be noted that according to Snell's law in order deflect light at a particular angle, say 25 degrees, the angle of incidence on the surface must be considerably larger than 25 degrees. FIG. 13, includes a plot 1302 that represents transmittance versus deflection angle when passing from a medium of index 1.6 (a typical value for visible light optics) into air. The X-axis in FIG. 13 is in radians. At the polar angle of 0.44 which is approximately equal to 25 degrees, the transmittance curve 1302 is already into a decline. The transmittance shown by plot 1302 is better than attained in practice because, at least, it does not take into account reflection losses experienced when light passes into the optic 502 through the bottom recess 504 of the optic. This is evidenced by reports of 90% and 85% efficiency for collimating versions of the optic as shown in FIG. 5, not 96% which is the starting value of plot 1302. In contrast, plot 1304 which applies to illumination lenses according to certain embodiments of the invention accounts for losses at both of two lens surfaces.

FIG. 14 shows another type of optic 1400 that is useful for illumination. This optic includes a saw tooth TIR section 1402 and a central lens portion 1404. The optic 1400 can collect a full hemisphere of emission from a source and forms an illumination pattern with a half-angle divergence (polar angle) about 30 degrees. This lens is disclosed in U.S. Pat. No. 5,577,492. For this type of optic there will be some loss of light from the intended distribution at the corners of the saw tooth pattern, which in practice may not be perfectly sharp due to manufacturing limitations. Additionally, due to its complex shape the cost of machining and polishing molds for injection molding is expected to be high. Additionally the '492 patent does address controlling the distribution of light within angular limits of the beams formed. The optic 1400 is already broad relative to its height. If an attempt were made to broaden the polar angle range of the illumination pattern, the TIR surfaces 1404 would have to be angled at larger angles, making the optic even broader-perhaps impractically broad

### BRIEF DESCRIPTION OF THE FIGURES

The present invention will be described by way of exemplary embodiments, but not limitations, illustrated in the accompanying drawings in which like references denote similar elements, and in which:

FIG. 1 is a graph of light intensity emission versus polar (zenith) angle for an LED;

FIG. 2 is a schematic view of a reflector arranged to collect and reflect some light emitted by an LED;

FIG. 3 is a primary optic for an LED;

FIG. 4 is a plot of light intensity versus polar angle produced by the primary optic shown in FIG. 3;

FIG. 5 is a secondary optic for an LED that produces a somewhat collimated light beam;

FIG. 6 is a plot of light intensity versus polar angle produced by the secondary optic shown in FIG. 5;

FIG. 7 is a top view of a pattern of ring convolutions that are added to a top surface of the secondary optic shown in FIG. 5 in order to obtain a broader angular distribution of light;

FIG. 8 is a broken out sectional view of the pattern of ring convolutions shown in FIG. 7;

FIG. 9 is a top view of an array of lenslets that are added to the top surface of the secondary optic shown in FIG. 5 also in order to obtain a broader angular distribution of light;

FIG. 10 is a broken out sectional view of the array of lenslets shown in FIG. 9;

FIGS. 11-12 show broader light intensity versus polar angle distributions of light that are obtained by adding light diffusing features such as shown in FIGS. 7-10;

FIG. 13 is a graph including plots of transmittance verses deflection angle for prior art illumination lenses and lenses according to embodiments of the present invention;

FIG. 14 is an illumination lens that includes a saw tooth TIR section in addition to a central lens portion;

FIG. 15 is a graph including an X-Z coordinate system and generatrices (profiles) of two surfaces a lens according to an embodiment of the invention;

FIG. 16 is a graph including the X-Z coordinate system and profiles of a refined version of the lens shown in FIG. 15 that has a modified positive draft portion of its outer surface to facilitate injection molding and a modified corresponding portion of the inner surface to compensate for the modified positive draft portion and maintain light distribution control;

FIG. 17 is a graph including the X-Z coordinate system and profiles of a lens for producing a more uniform light distribution than the bare LED and that has a modified positive draft portion of its inner surface to facilitate injection molding and a modified corresponding portion of the outer surface to compensate for the modified positive draft portion and maintain light distribution control;

FIG. 18 is a graph including the X-Z coordinate system and profiles of a lens that has a central refracting portion and outer Total Internal Reflecting wings that together distribute light in a controlled manner within a relatively narrow range centered on the Z-axis;

FIG. 19 is a graph including the X-Z coordinate system and profiles of a lens that has Total Internal Reflecting wings located at the top and a surrounding refracting portion that together distribute light in a controlled manner within a narrow angular range near the “equator” of a co-incident polar coordinate system;

FIG. 20 is plot showing light distributions produced by the lens shown in FIG. 16 and a similar lens compared to an ideal target distribution for uniformly illuminating a flat area (e.g., floor, wall, ceiling);

FIG. 21 is graph including the X-Z coordinate system and profiles of a lens similar to that shown in FIG. 15 but for producing a light distribution with a ˜65 degree half angle width;

FIG. 22 is a plot showing light distributions produced by the lens shown in FIG. 21 and a similar lens compared to an ideal target distribution for uniformly illuminating a flat area (e.g., floor, wall, ceiling);

FIG. 23 is graph including the X-Z coordinate system and profiles of a lens similar to that shown in FIG. 15 but for producing a light distribution with a ˜55 degree half angle width;

FIG. 24 is graph including the X-Z coordinate system and profiles of a lens similar to that shown in FIG. 18 but for producing a light distribution with a ˜25 degree half angle width;

FIG. 25 is graph including the X-Z coordinate system and profiles of a lens similar to that shown in FIG. 18 but for producing a light distribution with a ˜15 degree half angle width;

FIG. 26 shows the X-Z coordinate system with generatrices of lens that produces constant magnification;

FIG. 27 is a plan view of an LED based fluorescent replacement fixture that includes an array of the lenses according to an embodiment of the invention;

FIG. 28 is a plan view of a round recessed lighting fixture that uses several of the lenses according to an embodiment of the invention;

FIG. 29 shows a portion of an LED luminaire according to an embodiment of the invention;

FIG. 30 is a flowchart of a method of making lenses according to embodiments of the invention;

FIG. 31 is an exploded view of an LED illumination assembly that includes a half-lens and metal reflector positioned about an LED on a circuit board;

FIG. 32 is a top view of the assembly shown in FIG. 31;

FIG. 33 is an exploded view of an LED illumination assembly that includes a quarter-lens and metal reflector positioned about an LED on a circuit board;

FIG. 34 is a top view of the assembly shown in FIG. 33;

FIG. 35 is an exploded view of an LED illumination assembly that includes a two sector lens and metal reflector set positioned about an LED on a circuit board;

FIG. 36 is a top view of the assembly shown in FIG. 35;

FIG. 37 is a perspective view an alternative metal reflector suitable for use in combination with less than 2π azimuth range lens such as shown in FIGS. 31-36;

FIG. 38 shows a primary half-lens with a metalized back reflector;

FIG. 39 shows a strip form factor cove luminaire using a quadrant lens and mirror;

FIG. 40 is a schematic of an installation of the cove luminaire shown in FIG. 38;

FIG. 41 shows an application of a half-lens and mirror in a roadway luminaire;

FIG. 42 shows an application of a half-lens and mirror in an acorn style outdoor area luminaire; and

FIG. 43 is cross sectional side view of a LED illumination assembly including a half-lens metal reflector and remote phosphor half-dome.

### DETAILED DESCRIPTION

FIG. 15 is a plot of half-profiles (generatrices) of a first surface 1502 and a second surface 1504 of a lens 1506 according to an embodiment of the invention. The plots are shown in a coordinate system that includes an X-axis and a Z-axis. The surfaces 1502, 1504 are surfaces of revolution about the Z-axis (optical axis). The surfaces 1502, 1504 are joined by an annular edge surface 1508. The surfaces 1502, 1504 bound a body of transparent material, e.g., glass, plastic, silicone. The origin of the coordinate system corresponds to the location of the light source (e.g., an LED). By loose analogy to imaging optics, the origin of the X-Z coordinate system can be considered the one and only focus of the lens 1506. A single ray 1510 is shown emitted from the origin and refracted by the lens surfaces 1502, 1504. Various angles phi1, phi2, phi3 as will be described below are shown.

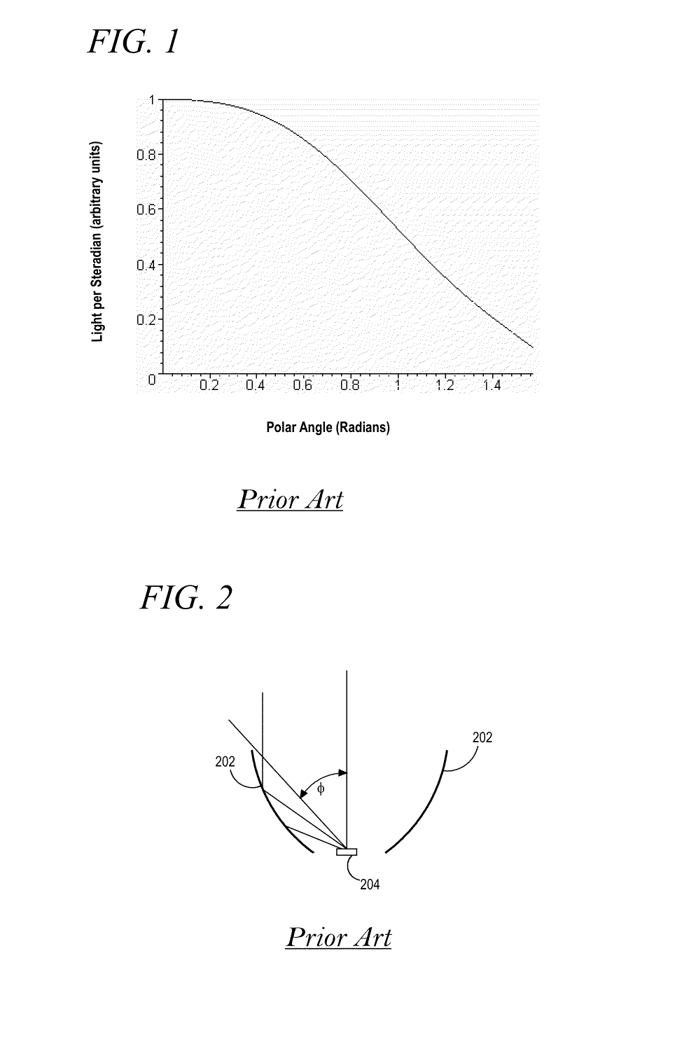

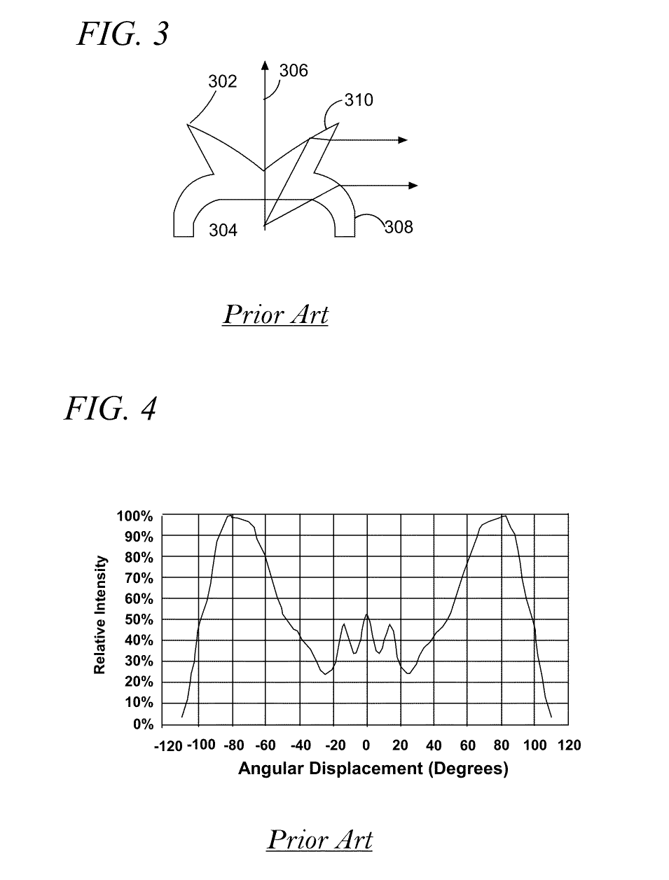

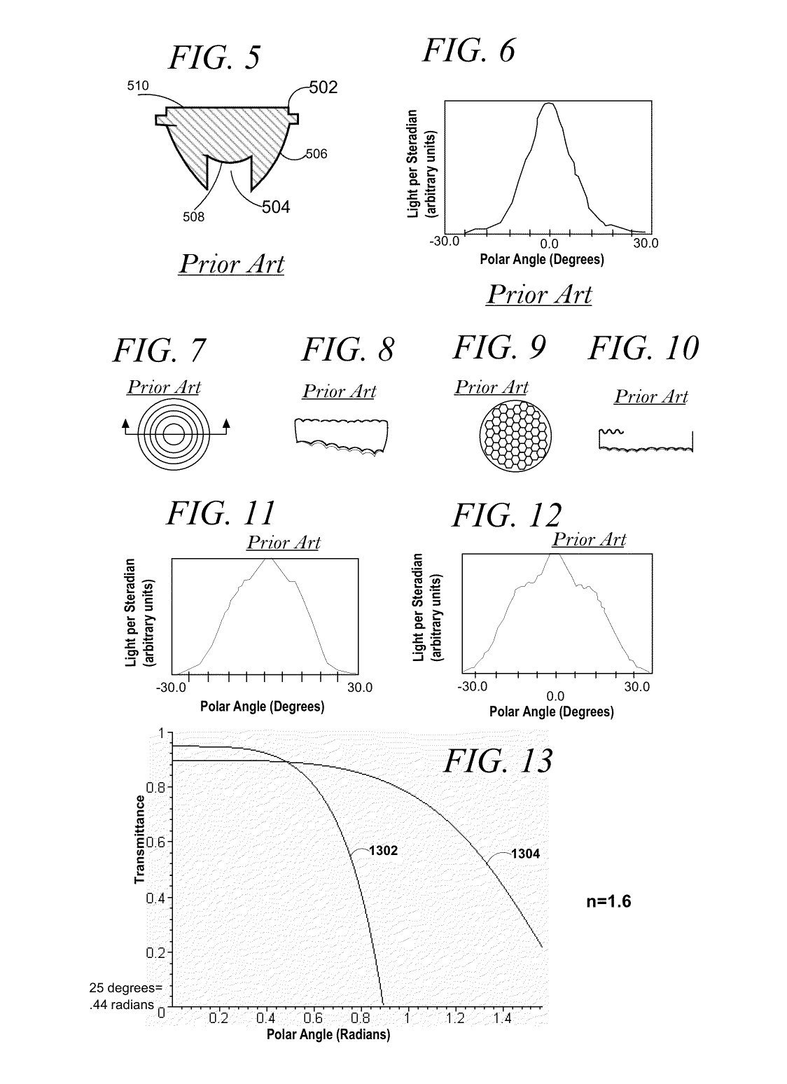

According to embodiments of the invention illumination lenses have a first surface 1502 and a second surface 1504 such as shown in FIG. 1 shaped according to the following coupled differential equations:

$$\begin{matrix}\frac{\partial }{\partial φ1} r 1 ( φ1 ) = \frac{r 1 n 2 sin ( \frac{1}{2} φ1 - \frac{1}{2} φ3 )}{n 2 cos ( \frac{1}{2} φ1 - \frac{1}{2} φ3 ) - n 1} & DE1 \\ \frac{\partial }{\partial φ1} r 2 = r 2 ( φ1 ) tan ( \% 3 - arcsin ( \frac{r 1 ( φ1 ) sin ( \% 4 )}{r 2 ( φ1 )} ) ) & DE2 \\ ( 1 - ( \frac{n 1 cos ( \% 1 ) \% 5}{( n 2 cos ( \% 1 ) - n 1 ) \sqrt{\% 2}} + \frac{n 1 {sin ( \% 1 )}^{2} n 2 \% 5}{{( n 2 cos ( \% 1 ) - n1 )}^{2} \sqrt{\% 2}} - & \\ \frac{1}{2} \frac{n 1 sin ( \% 1 ) ( \begin{matrix}2 \frac{n {2}^{2} sin ( \% 1 ) cos ( \% 1 ) \% 5}{{( n 2 cos ( \% 1 ) - n 1 )}^{2}} + \\ 2 \frac{n {2}^{3} {sin ( \% 1 )}^{3} \% 5 )}{{( n 2 cos ( \% 1 ) - n 1 )}^{3}}\end{matrix} )}{( \frac{3}{2} )} ) / & \\ ( n 2 cos ( \% 1 ) - n 1 ) \% 2 \sqrt{1 - \frac{n {1}^{2} {sin ( \% 1 )}^{2}}{{( n 2 cos ( \% 1 ) - n 1 )}^{2} \% 2}} + & \\ \frac{\frac{n 2 cos ( \% 1 ) \% 5}{n 2 cos ( \% 1 ) - n 1} + \frac{n {2}^{2} {sin ( \% 1 )}^{2} \% 5}{{( n 2 cos ( \% 1 ) - n 1 )}^{2}}}{\% 2} - ( \frac{\frac{\partial }{\partial φ1} r 1 ( φ1 ) sin ( \% 4 )}{r 2 ( φ1 )} + & \\ \sqrt{1 - \frac{r 1 {( φ1 )}^{2} {sin ( \% 4 )}^{2}}{r 2 {( φ1 )}^{2}}} ) / ( 1 - \frac{tan ( \% 3 - arcsin ( \frac{r 1 ( φ1 ) sin ( \% 4 )}{r 2 ( φ1 )} ) ) r 1 ( φ1 ) sin ( \% 4 )}{r 2 ( φ1 ) \sqrt{1 - \frac{r 1 {( φ1 )}^{2} {sin ( \% 4 )}^{2}}{r 2 {( φ1 )}^{2}}}} ) & \\ \%1 := - \frac{1}{2} φ1 + \frac{1}{2} φ3 ( φ1 ) & \\ \%2 := 1 + \frac{n {2}^{2} {sin ( \% 1 )}^{2}}{{( n 2 cos ( \% 1 ) - n 1 )}^{2}} & \\ \%3 := arcsin ( \frac{n 1 sin ( \% 1 )}{( n 2 cos ( \% 1 ) - n1 ) \sqrt{\% 2}} ) & \\ \%4 := - \%3 + arctan ( \frac{n 2 sin ( \% 1 )}{n 2 cos ( \% 1 ) - n 1} ) & \\ \%5 := - \frac{1}{2} + \frac{1}{2} ( \frac{\partial }{\partial φ1} φ3 ( φ1 ) ) & \end{matrix}$$

Where:

n2 is the index of refraction of the lens 1506 defined by the equations;
n1 is the index of refraction of the surrounding medium (e.g., of air) which usually equals 1;
phi1 is the polar angular coordinate (zenith angle) of the first lens surface;
phi3 is the polar angle (zenith angle) of an ideal ray (a ray emitted at the origin) that was initially emitted at angle phi1 after the ray has left the second surface 1504 of each lens defined by the equations (see FIG. 15) and is given by:

$$\frac{{\int }_{φ1\_ MIN}^{φ1} rad\_in ( φ1 ) \cdot 2 π \cdot sin ( φ1 ) d φ1}{{\int }_{φ1\_ MIN}^{φ1\_ MAX} rad\_in ( φ1 ) \cdot 2 π \cdot sin ( φ1 ) d φ1} = \frac{{\int }_{φ3\_ MIN}^{φ3} rad\_out ( φ3 ) \cdot 2 π \cdot sin ( φ3 ) d φ3}{{\int }_{φ3\_ MIN}^{φ3\_ MAX} rad\_out ( φ3 ) \cdot 2 π \cdot sin ( φ3 ) d φ3} \qquad EQU . 1$$

where,

phi1_MIN and phi1_MAX are the lower and upper limits polar angle limits respectively of light collected by each lens 1506 defined by the equations; phi3_MIN and phi3_MAX are the lower and upper limits respectively of a predetermined specified output light intensity distribution for each lens 1506 defined by the equations;

rad_in(phi1) is the light intensity distribution of the light source (e.g., LED) for which the lens 1506 is designed; and
rad_out(phi3) is the predetermined specified output light intensity distribution for each lens defined by the equations;
phi2 is a polar angular coordinate of the second lens surface and is given by:

$$\begin{matrix}φ2 = φ1 + arcsin ( \frac{n 1 sin ( \% 1 )}{( - n 2 cos ( \% 1 ) + n 1 ) \sqrt{\frac{n {2}^{2} {sin ( \% 1 )}^{2}}{{( - n 2 cos ( \% 1 ) + n 1 )}^{2}} + 1}} ) - arctan ( \frac{n 2 sin ( \% 1 )}{- n 2 cos ( \%1 ) + n 1} ) - arcsin ( r 1 ( φ1 ) sin ( arcsin ( \frac{n 1 sin ( \% 1 )}{( - n 2 cos ( \% 1 ) + n 1 ) \sqrt{\frac{n {2}^{2} {sin ( \% 1 )}^{2}}{{( - n 2 cos ( \% 1 ) + n 1 )}^{2}} + 1}} ) - arctan ( \frac{n 2 sin ( \% 1 )}{- n 2 cos ( \% 1 ) + n 1} ) ) / r 2 ( φ1 ) ) \\ \\ \%1 := - \frac{1}{2} φ1 + \frac{1}{2} φ3 ( φ1 ) \\ and & EQU . 2 \\ \frac{\partial φ3}{\partial φ1} = ( \frac{rad\_out ( φ1 ) \cdot 2 π \cdot sin ( φ1 )}{rad\_in ( φ3 ) \cdot 2 π \cdot sin ( φ3 )} ) \cdot ( \frac{{\int }_{φ3\_ MIN}^{φ3\_ MAX} rad\_in ( φ3 ) \cdot 2 π \cdot sin ( φ3 ) d φ3}{{\int }_{φ1\_ MIN}^{φ1\_ MAX} rad\_out ( φ1 ) \cdot 2 π \cdot sin ( φ1 ) d φ1} ) & EQU . 3\end{matrix}$$

with initial conditions r1_ini and r2_ini for r1(phi1) and r2(phi1) respectively

EQU. 1 is solved numerically to obtain a value of phi3 for each input value of phi1 and DE1 and DE2 are integrated numerically, e.g., using the Runge Kutta integrator.

If phi1_min=phi3_min=0, EQU. 3 will be undefined at phi1_min=0. In this case, instead of using EQU. 3.0 one can use the values of phi3 obtained from EQU. 1 at two closely spaced points (e.g., spaced by 0.001) to obtain a finite difference approximation to dphi3/dphi1.

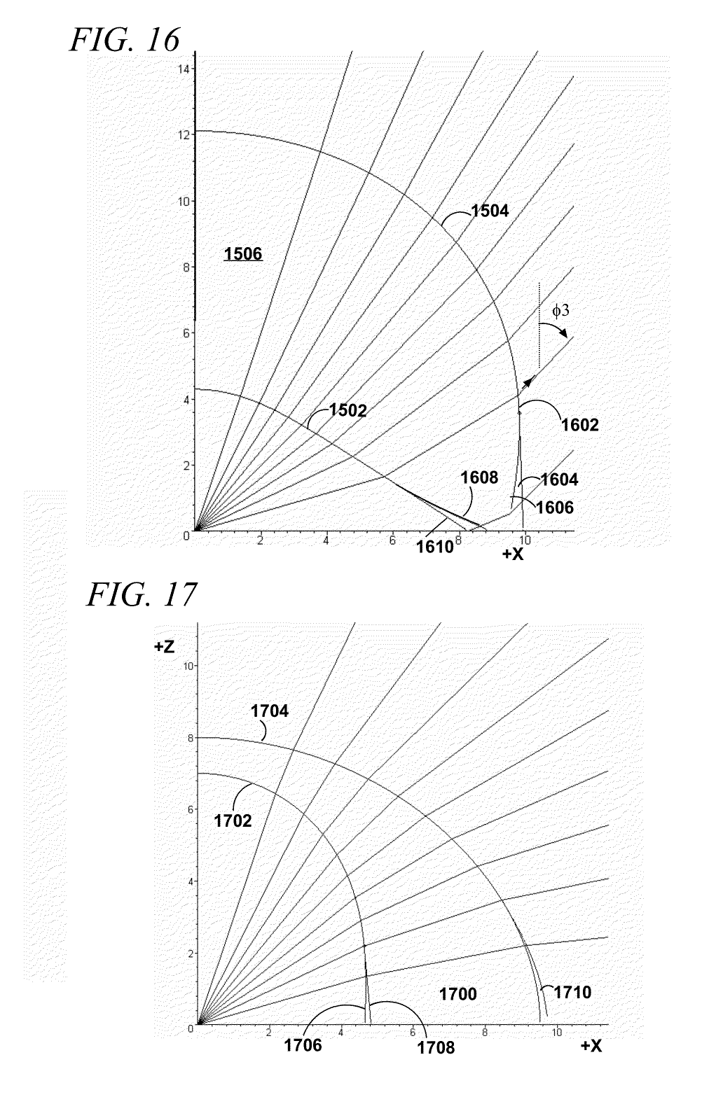

The most economical way to make the lens 1506 (and other embodiments described by the equations given above and below) is by molding e.g. injection molding or glass molding. To simplify the construction of the molds used to mold the lens 1506, the first lens surface 1502 can be molded by the core of the mold and the second lens surface 1504 by the cavity of the mold. (This may not be possible for all versions of the lens 1506.) Best practice in injection molding is to have a draft angle of one-half to a few degrees. The design of the part to be molded and the mold cannot be such that the solidified molding material will be locked into the mold. Referring to FIG. 15 it is seen that at location 1512 the second surface 1504 of the lens is vertical (parallel to the Z-axis). Versions of the lens 1506 in which this condition occurs could be injection molded with a mold that has a parting line at location 1512, but this would not be best, as the gate residual would have to be cut from the lens surface. A solution to this problem is as follows. The lens equations given above are integrated to an intermediate value of phi1 (corresponding to a value of phi2) at which the second surface 1504 has a slope corresponding to a desired draft angle and then second surface 1504 of the lens is extended downward at that draft angle. In FIG. 16 the intermediate point which in this example corresponds to a draft angle of two degrees is labeled with reference numeral 1602. The extension of the second surface at the draft angle is labeled 1604. The portion extended at the draft angle 1604 is frusto-conical. The portion of the profile of the second surface 1504 that is replaced by the extension 1604, is labeled 1606. The second surface need only be extended down far enough to intersect a ray emitted at phi1_MAX, after that ray has been refracted by the first surface 1502, but can be extended further. For example, integrally molded mounting features such as mounting flanges and standoff pins can be located below the surfaces defined by the generatrices shown in the FIGs. Because the extension at the draft angle 1604 differs from the replaced section 1606, light rays would not, if nothing else were done, be directed out of the lens at the correct angles. To resolve this, and correct the deflection of rays back to what would be obtained in the original lens 1506, a portion of the first lens surface 1502 that refracts light to the draft angle extension 1604 is redefined by the following equation.

$$\frac{\partial }{\partial φ1} r 1 ( φ1 ) = - \frac{r 1 n 2 cos ( φ1 - phiD + arcsin ( \frac{n 1 cos ( - φ3 + phiD )}{n 2} ) )}{n 2 sin ( φ1 - phiD + arcsin ( \frac{n 1 cos ( - φ3 + phiD )}{n 2} ) ) - n 1} \qquad DE3$$

where, r1, n1, n2 phi1, phi3 are as defined above; and
phiD is a specified draft angle.

(Note that in order to maintain consistency with the definitions of phi1, phi2 and phi3 (see FIG. 15), positive values of phiD are measured clockwise from the Z-axis, thus what is referred to as a positive draft angle in the injection molding art, will be entered as a negative value in DE3)

The redefined portion of the first lens surface 1502, defined by DE3 is labeled 1608 in FIG. 16. The portion it replaces is labeled 1610. If the first surface 1502 were not modified by using DE3 to defined the portion 1608 light would be refracted by the draft angle extension 2104 to polar angles beyond phi3_max. (Note that some amount of light may be directed beyond phi3_max due to lack of perfect clarity of the lens, and the finite light source size, the latter factor being subject to mitigation by increasing the size of the lens 1506 relative to the source).

Using the draft angle extension 1604 of the second surface 1504 and the redefined portion 1608 of the first surface 1502 slightly reduces the transmittance of the lens but the amount of decrease is insignificant because of the small percentage of light effected by the redefined surfaces 1604, 1608, and because the changes in the angle of incidences due to the redefinition is small.

Note that DE1, DE2 and DE3 are defined in the domain of phi1. In order to find the value of phi1 at which to start the draft extension 1604 and switch to using DE3, the following equation is used:

$$phiD = φ2 - \frac{π}{2} - theta\_i2 \qquad EQU . 4$$

where, phi2 is given above by EQU. 2; and
theta_i2 is given by:

$$\begin{matrix}theta\_i2 = arcsin ( \frac{n 1 sin ( \% 1 )}{( n 2 cos ( \% 1 ) - n 1 ) \sqrt{\frac{n {2}^{2} {sin ( \% 1 )}^{2}}{{( n 2 cos ( \% 1 ) - n 1 )}^{2}} + 1}} ) - \\ arcsin ( r 1 ( φ1 ) sin ( - arcsin ( \frac{n 1 sin ( \%1 )}{( n 2 cos ( \% 1 ) - n 1 ) \sqrt{\frac{n {2}^{2} {sin ( \% 1 )}^{2}}{{( n 2 cos ( \% 1 ) - n 1 )}^{2}} + 1}} ) + \\ arctan ( \frac{n 2 sin ( \% 1 )}{n 2 cos ( \% 1 ) - n 1} ) ) / r 2 ( φ1 ) ) \%1 := - \frac{1}{2} φ1 + \frac{1}{2} φ3 ( φ1 )\end{matrix} \qquad EQU . 5$$

and where, n1, n2, phi1, phi3, r1 and r2 are as defined above.

To use EQU. 4 (with sub-expressions defined by EQU. 2 and EQU. 5) a selected draft angle (e.g., ½ to a few degrees) is entered for PhiD and the EQU. 4 is solved numerically for phi1 using a root finding method. Note that each evaluation of EQU. 4 will involve integrating DE1 and DE2 up to a value phi1 in order to determine r1, r2. Once a value of phi1 corresponding to phiD is found, a corresponding value of r1 for the initial condition for DE3 can be found by integrating DE1 up to this value of phi1. The value of phi1 found in this way is referred to herein below as phi1 at phiD.

For each of several examples discussed herein a table of inputs to the lens equations is given. The table for the lens represented in FIG. 16 is:

TABLE I

| Phi1_MIN | 0.0 radians |
|---|---|
| Phi1_MAX | 1.57 radians (90 degrees) |
| Phi3_MIN | 0.0 radians |
| Phi3_MAX | 0.873 radians (45 degrees) |
| PhiD | −0.035 radians (−2.0 degrees) |
| Phi1 at phiD | 1.33 radians (76.2 degrees) |
| rad_in(phi1) | FIG. 1 |
| rad_out(phi3) | cos(phi3)\hat{ }(−3.5) |
| | (highly uniform on plane) |
| r1_ini | 4.3 |
| r2_ini | 12.118 |
| n1 | 1.0 |
| n2 | 1.497 (PMMA) |
| Phi_start | Phi1_MIN |
| Calculated Transmission | 91.7% |

Note that although the initial conditions and dimensions shown in the FIGs. can be considered to be in arbitrary units (meaning that scaling is possible), the values were selected with millimeter units in mind. In fact, a prototype discussed below was made with these dimension in millimeters. The second to last row in the tables determines the Phi1 value at which the initial conditions r1_ini and r2_ini are defined. The choice of r1_ini and r2_ini is not critical. The difference between r1_ini and r2_ini should be chosen to give a designed initial lens thickness. Alternatively, r2_can be adjusted to give a certain lens diameter. One caveat is that if r1_ini and r2_ini are chosen too close the profiles given by the lens equations may cross-over which is physically excluded. The solution to this problem is to choose r1_ini and r2_ini further apart and reintegrate the lens equations. Also, a smaller difference between r1_ini and r2_ini will lead to a faster mold cooling time and therefore increased manufacturing productivity. Furthermore r1_ini must be large enough to accommodate the LED.

The lens shown in FIG. 16 collects light energy from a full hemisphere of solid angle from an LED and distributes the light substantially uniformly on an area of a plane (e.g., floor, ceiling or wall). Additionally, the light is substantially confined to a cone of polar angle (zenith angle) 45 degrees. This is a good polar angle limit for flood lighting. Some luminaires used for general lighting emit light in even broader angular ranges. The lens can readily be adapted to emit over larger angular ranges by adjusting phi3_max. Of course, uniform illumination of an area of a plane cannot be obtained without limits on phi3_max because as phi3_max approaches Pi/2 the light energy requirement for any finite illumination level goes to infinity.

In FIG. 16 a series of design rays 1602 are shown emanating from the origin and traced through the lens 1506. (Only two are connected to lead lines so as not to crowd the drawings). One ray which is not visible is along the +Z axis. Another ray which is initially not visible is emitted along the +X axis and is then refracted at an angle by the lens. These are all ideal rays emanating from the origin of the X-Z coordinate system. The initial angles of these rays are not arbitrary, rather the angles are selected to divide the light energy emitted by the light source (e.g., LED) into equal energy portions. Doing so helps to visualize how the lens redistributes energy.

For certain combinations of the bare LED light distribution rad_in and the desired output light distribution rad_out, DE1 defines a profile of the first surface of the lens that has a negative draft near its edge (positive in the convention of the present description) leading to an “undercut” condition. Such a lens could not be molded using a straight forward mold design because the inner surface would lock onto the core of the mold as the lens material hardened. Such a lens might be made using a more expensive method e.g., using a core made of a low temperature meltable material that is melted out. An example where the first surface negative draft condition occurs is in the case that rad_in is nearly Lambertian as shown in FIG. 1 and rad_out is set equal to 1.0 in order to more uniformly distribute the light from an LED. FIG. 17 illustrates this example along with lens profile corrections that are discussed below. FIG. 17 shows a generatrix 1702 of a lens inner surface given by DE1 and a generatrix 1704 of the lenses outer surface given by DE2 in combination with DE1. A lower portion 1706 of the generatrix 1702 of the inner surface has a negative draft. In order to address this problem a portion of the inner lens surface 1702 starting from a point at which the surface reaches a suitable draft angle (e.g., ½ to 5 degrees) is replaced by a conical portion 1708 that continues at that draft angle. In order to compensate for the change of the inner surface, a portion 1710 of the outer surface is redefined according to the following lens equation:

$$\frac{\partial }{\partial φ1} r2\_d1 = r2\_d1 ( φ1 ) tan ( \begin{matrix}arctan ( \frac{n 1 cos ( φ3 - phiD + \% 2 )}{n 1 sin ( φ3 - phiD + \% 2 ) - n 2} ) - \\ arcsin ( \frac{r1\_switch \% 4 \% 3}{\% 1 r2\_d1 ( φ1 )} )\end{matrix} ) ( \frac{n 1 sin ( φ1 - phiD )}{n 2 \sqrt{1 - \frac{n {1}^{2} {cos ( φ1 - phiD )}^{2}}{n {2}^{2}}}} - ( - \frac{r1\_switch \% 4 \% 3 ( - tan ( phiD ) sin ( φ1 ) - cos ( φ1 ) )}{\% {1}^{2} r2\_d1 ( φ1 )} - \frac{r1\_switch \% 4 sin ( φ1 - phiD + \% 2 ) ( 1 - \frac{n 1 sin ( φ1 - phiD )}{n 2 \sqrt{1 - \frac{n {1}^{2} {cos ( φ1 - phiD )}^{2}}{n {2}^{2}}}} )}{\% 1 r 2 \_d 1 ( φ1 )} ) / \sqrt{1 - \frac{r 1 {\_switch}^{2} \% {4}^{2} \% {3}^{2}}{\% {1}^{2} r 2 \_d 1 {( φ 1 )}^{2}}} ) / ( 1 - tan ( arctan ( \frac{n 1 cos ( φ3 - phiD + \% 2 )}{n 1 sin ( φ3 - phiD + \% 2 ) - 2} ) - arcsin ( \frac{r1\_switch \% 4 \% 3}{\%1 r2\_d1 ( φ1 )} ) ) r1\_switch \% 4 \% 3 / ( r2\_d1 ( φ1 ) \% 1 \sqrt{1 - \frac{{r1\_switch}^{2} \% {4}^{2 } \% {3}^{2}}{\% {1}^{2} r2\_d1 ( φ1 )}} ) ) \\ \%1 := tan ( phiD ) cos ( φ1 ) - sin ( φ1 ) \\ \%2 := arcsin ( \frac{n 1 cos ( φ1 - phiD )}{n 2} ) \\ \%3 := cos ( φ1 - phiD + \% 2 ) \\ \%4 := tan ( phiD ) cos ( phi1\_phiD ) - sin ( phi1\_phiD ) \qquad DE4$$

where, n1, n2 phi1, phi3, phiD are as defined above;
r2_d1 is the polar radial coordinate of the redefined portion 1710 of the second lens surface 1704;
phi1_phiD is the value of phi1 at phiD on the first surface defined by DE1;
r1_switch is the polar radial coordinate of the point on the first surface 1702 at which the switch is made to the conical portion 1708, i.e., r1(phi1_phiD)=r1_switch.
Although DE4 is defined in the domain of phi1, the polar angular coordinate phi2 of the redefined portion 1710 is given by:

$$phi2\_d1 = \frac{1}{2} π + phiD - arcsin ( \frac{n 1 cos ( φ1 - phiD )}{n 2} ) - arcsin ( r1\_switch ( tan ( phiD ) cos ( phi1\_phiD ) - sin ( phi1\_phiD ) ) cos ( φ1 - phiD + arcsin ( \frac{n 1 cos ( φ1 - phiD )}{n 2} ) ) / ( ( tan ( phiD ) cos ( φ1 ) - sin ( φ1 ) ) r2\_d1 ( φ1 ) ) ) \qquad EQU . 6$$

Cartesian coordinate of the redefined portion 1710 can be obtained from r2_d1 and phi2_d1.
In order to find the value of phi1 at which the inner lens surface has an angle equal to a desired draft the following equation is used:

$$phiD = φ1 - \frac{π}{2} - θ1 \qquad EQU . 7$$

where theta_{—}1 is the angle of incidence of ideal rays on the first surface and is given by:

$$θ1 := - arctan ( \frac{n 2 sin ( - \frac{1}{2} φ1 + \frac{1}{2} φ3 ( φ1 ) )}{n 2 cos ( - \frac{1}{2} φ1 + \frac{1}{2} φ3 ( φ1 ) ) - n 1} ) \qquad EQU . 8$$

As in the case of EQU.4, EQU. 7 (with theta_{—}1 defined by EQU. 8) is used by plugging in a selected value for phiD (e.g., ½ to a few degrees) and using a root finding method to find the value of phi1 that balances EQU. 7. Table II below list information for the lens shown in FIG. 17.

TABLE II

| Phi1_MIN | 0.0 radians |
|---|---|
| Phi1_MAX | 1.57 radians (90 degrees) |
| Phi3_MIN | 0.0 radians |
| Phi3_MAX | 1.57 radians (90 degrees) |
| PhiD | −0.087 radians (−5.0 degrees) |
| Phi1_phiD | 1.13 radians (64.7 degrees) |
| rad_in(phi1) | FIG. 1 |
| rad_out(phi3) | 1.0 (uniform goal) |
| r1_ini | 7.0 |
| r2_ini | 9.0 |
| n1 | 1.0 |
| n2 | 1.497 (PMMA) |
| Phi_start | Phi1_min |
| Calculated Transmission | 92.19% |

FIG. 17 illustrates the ability to change the distribution of light within the angular bounds of light emitted by the source without changing the bounds themselves. Note that Phi1_MIN=Phi3_MIN=0.0 and Phi1_MAX=Phi3_MAX=1.57 (90 degrees). The version of the lens shown in FIG. 17 makes the light output more uniform than the bare LED.

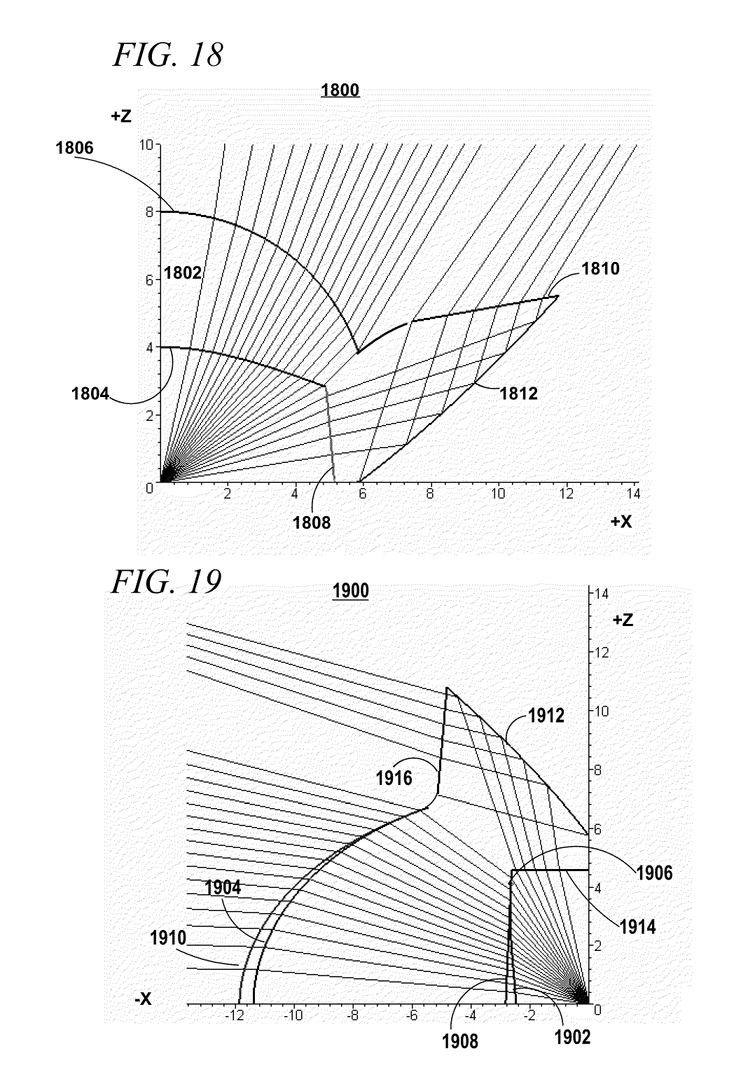

As shown by plot 1304 in FIG. 13 as the deflection angle increases beyond a certain point the transmission of the lens drops off precipitously. For certain lighting tasks a narrow distribution of light is desirable. If a high collection efficiency is to be maintained by keeping phi1_max at 90 degrees then a higher deflection angle is needed in order to produce a narrower distribution of light. FIG. 18 shows generatrices of a lens 1800 that includes a central portion 1802 that has a first surface 1804 and a second surface 1806 defined by DE1 and DE2 and also has a conical surface 1808, an exit surface 1810 and a Total Internal Reflection (TIR) surface 1812 given by DE5 below. The TIR surface defined by DE5 works in concert with the central portion 1802 to continue the overall light intensity distribution specified by rad_out.

$$\begin{matrix}\frac{\partial }{\partial φ1} r2\_w = - r2\_w ( φ1 ) tan ( \frac{1}{4} π - \frac{1}{2} phi\_draft + \frac{1}{2} arcsin ( \frac{n 1 \%2}{n 2} ) - & DE 5 \\ \frac{1}{2} arcsin ( \frac{n 1 sin ( phi\_exit - φ3 )}{n 2 } ) + \frac{1}{2} phi\_exit + arc sin & \\ ( \frac{r1\_switch \% 4 cos ( \%3 )}{\%1 r2\_w ( φ1 )} ) ) ( - \frac{n 1 sin ( - φ1 + phi\_draft )}{n 2 \sqrt{1 - \frac{n {1}^{2} {\%2}^{2}}{n {2}^{2}}}} - & \\ \frac{r1\_switc h \% 4 cos ( \% 3 ) ( - tan ( phi\_draft ) sin ( φ1 ) - cos ( φ1 ) )}{\% {1}^{2} r2\_w ( φ1 ) )} - & \\ \frac{r1\_switch \% 4 sin ( \%3 ) ( 1 + \frac{n 1 sin ( - φ1 + phi\_draft )}{n 2 \sqrt{1 - \frac{n {1}^{2 } \% {2}^{2}}{n {2}^{2}}}} )}{\% 1 r2\_w ( φ1 )} ) / & \\ \sqrt{1 - \frac{{{r1\_switch}^{2} }^{ } \% {4}^{2} {cos ( \% 3 )}^{2}}{\% {1}^{2} r2\_w ( φ1 ) )}} + ) / & \\ ( 1 + tan ( \frac{1}{4} π - \frac{1}{2} phi\_draft + \frac{1}{2} arcsin ( \frac{n 1 \% 2}{n 2} ) - & \\ \frac{1}{2} arcsin ( \frac{n 1 sin ( phi\_exit - φ3 )}{n 2} ) + \frac{1}{2} phi\_exit + arcsin & \\ ( \frac{r1\_switch \% 4 cos ( \% 3 )}{\% 1 r2\_w ( φ1 )} ) ) r1\_switch \% 4 cos ( \% 3 ) ) / & \\ r2\_w ( φ1 ) \% 1 \sqrt{1 - \frac{{r1\_switch}^{2} \% {4}^{2} {cos ( \% 3 )}^{2}}{{\%1}^{2} {r}^{2} \_w {( φ1 )}^{2}}} ) & \\ \%1 := tan ( phi\_draft ) cos ( φ1 ) - sin ( φ1 ) & \\ \%2 := cos ( - φ1 + phi\_draft ) & \\ \%3 := φ1 - phi\_draft + arcsin ( \frac{n 1 \% 2}{n 2} ) & \\ \%4 := tan ( phi\_draft ) cos ( phi1\_switch ) - sin ( phi1\_switch ) & \end{matrix}$$

Where, n1, n2, phi1, phi3 are as defined above;
r2_w is the polar radial coordinate of the TIR surface 1812;
r1_switch is the polar radial coordinate of the top of the conical surface 1808 (also in the case of FIG. 18 the point at which the conical surface 1808 meets the first surface 1804 defined by DE1.)
phi1_switch is the polar angular coordinate of the top of the conical surface 1808;
phi_draft is the angle of the conical surface 1808 measured in the clockwise direction from the positive Z-axis;
phi_exit is the angle of the surface normal of the exit surface measured in the clockwise direction from the positive Z-axis,
with initial condition r2_w_ini.
The polar angular coordinate (zenith angle) of the TIR surface 1812 is given by the following equation.

$$phi 2 w = \frac{1}{2} π + phi\_draft - arcsin ( \frac{n 1 cos ( - φ1 + phi\_draft )}{n 2} ) - arcsin ( r1\_switch ( tan ( phi\_draft ) cos ( phi1\_switch ) - sin ( phi1\_switch ) ) cos ( φ1 - phi\_draft + arcsin ( \frac{n 1 cos ( - φ1 + phi\_draft )}{n 2} ) ) / ( tan ( phi\_draft ) cos ( φ1 ) - sin ( φ1 ) ) r2\_w ( φ1 ) ) ) \qquad EQU . 9$$

r1_w and phi2w together define the TIR surface 1812 in polar coordinates. Cartesian coordinates can be obtained from them.

In embodiments such as shown in FIG. 18 phi_draft has a small negative value to allow the lens 1800 to release from a mold. A more negative phi_draft will tend to increase the size of the TIR surface 1812. On the other hand a more negative value of phi_exit tends to reduce the size of the TIR surface. Both phi_draft and phi_exit should be selected (using phi1_max, phi1_switch and phi3_max as points of reference) to avoid large angles of incidence that would reduce light transmission. Note that the exit surface 1810 can be raised slightly from the top edge of the TIR surface 1812 in order to provide a peripheral location for an injection molding gate. The portion of the lens 1800 between the conical surface 1808, the exit surface 1810 and the TIR surface 1812 is referred to herein as the “TIR wings”. Table III below lists information for the lens shown in FIG. 18.

TABLE III

| Phi1_MIN | 0.0 radians |
|---|---|
| Phi1_MAX | 1.57 radians (90 degrees) |
| Phi3_MIN | 0.0 radians |
| Phi3_MAX | 0.61 radians (35 degrees) |
| Phi_draft | −0.087 radians (−5.0 degrees) |
| Phi_exit | −0.174 radians (−10.0 degrees) |
| Phi1_switch | 1.047 radians (60.0 degrees) |
| rad_in(phi1) | FIG. 1 |
| rad_out(phi3) | cos(phi3)\hat{ }(−3) |
| | (uniform on plane goal) |
| r1_ini | 4.0 |
| r2_ini | 8.0 |
| r2_w_ini | 13.0 |
| n1 | 1.0 |
| n2 | 1.497 (PMMA) |
| Phi_start | Phi1_min for DE1, DE2 |
| | Phi1_switch for DE5 |
| Calculated Transmission | 91.73% |

Whereas the TIR wings shown in FIG. 18 are useful in confining light to smaller angular range around the Z axis, the TIR wings defined by DE5 can also be used to confine light to a small angular range near phi3=π/2 (near the “equator” of a the spherical coordinate system). FIG. 19 shows a lens 1900 that does this. In order to use the differential equations given above to define a lens having TIR wings at the top as shown in FIG. 19 the differential equations are integrated to the left of the Z-axis, i.e., with negative values of the phi variables. Note rad_out and rad_in are generally assumed to be symmetric so using negative phi values does not change these light distributions. FIG. 19 shows a generatrix of a first surface 1902 defined by DE1 and a corresponding generatrix of a second surface 1904 defined by DE2 in combination with DE1. The first surface 1902 has a negative draft meaning that it would lock onto the core of a mold and could not be removed. To resolve this, most of the first surface starting from point 1906 at which phiD=−177.5 degrees (a positive draft angle of 2.5 degrees) was replaced by a constant draft conical section 1908 and a corresponding portion of the second surface 1904 was replaced by a second surface 1910 defined by DE4. The TIR wings of lens 1900 include a TIR reflecting surface 1912 defined by DE5, a constant draft surface 1914 and an exit surface 1916. In this special case in which phi_draft=−90 degrees the constant draft surface 1914 is planar, as opposed to conical. Table IV below gives information about the lens shown in FIG. 19.

TABLE IV
General Information

| | |
|---|---|
| Phi1_MIN | 0.0 radians |
| Phi1_MAX | −1.57 radians (−90 degrees) |
| Phi3_MIN | −1.22 radians (−70 degrees) |
| Phi3_MAX | −1.57 radians (−90 degrees) |
| n1 | 1.0 |
| n2 | 1.497 (PMMA) |
| rad_in(phi1) | FIG. 1 |
| rad_out(phi3) | 1.0 |
| | (uniform goal) |
| Phi_start | Phi1_max for DE1, DE2 |
| | Phi1_switch for DE5 |
| | phi1_phiD for DE4 |
| Calculated | 91.023% |
| Transmittance | |

Information Related to Refractive Lens Part defined by
DE1, DE2

| | |
|---|---|
| r1_ini | 2.5 |
| r2_ini | 11.4 |

Information Related to Refractive Lens Part redefined by
DE4

| | |
|---|---|
| PhiD | −3.097 radians (−177.5 degrees) |
| phi1_phiD | −.578 radians (−33.1 degrees) |
| R1_switch | 4.86 |
| R2_switch | 8.87 |

Information Related to TIR wings defined by DE5

| | |
|---|---|
| Phi1_switch | −.523 radians (−30.0 degrees) |
| Phi_draft | −1.57 radians (−90 degrees) |
| Phi_exit | −1.48 radians (−85 degrees) |
| r2_w_ini | 11.8 |

R2_switch is the initial condition for DE5 which in the case of the lens represented in FIG. 19 was integrated starting at phi1_phiD. R2_switch was the final value of r2 given by DE2 at phi1_phiD.

Lenses defined by the lens equations given above are able to collect a full hemisphere of light emitted by an LED, and are able to distribute the light in a controlled manner. At the same time surfaces of the lens defined by these equations are shaped to reduce transmittance losses. The examples described while providing a wide variety of light distributions hardly lose any more light by reflection than would an optical window at normal incidence. The calculated transmittances for the lens examples described herein are negligibly different from the transmittance for light passing perpendicularly through an optical window. As illustrated above, many practical general illumination lenses defined by the differential equations given above the calculated transmittance is over 90%. The second curve 1304 in FIG. 13 gives transmittance as a function of deflection angle for lenses defined by DE1 and DE2. The deflection angle is equal to (phi3−phi1). For normal incidence the transmittance through both surfaces, based on an index of 1.497, is 92.2%%. A transmittance of 90% represents a high optical luminaire efficiency compared to standard luminaires. Also, reflected light may eventually scatter out of the lens into the beam pattern. This effect may be increased making the area under the lens surrounding the LED reflective. The optical luminaire efficiency is defined as the percentage of light emitted by a light source (e.g., LED) that is output by an associated luminaire which in the present case includes the lenses defined by the above differential equations.

There is another efficiency factor that is termed herein “pattern efficiency” and is related to the percentage of light energy in an output distribution of light that is in excess of a required light intensity. Because the light distribution patterns produced by most luminaries (e.g., flood lamps, downlights) is stronger in a central part of an angular or spatial range that is intended to be illuminated, the total power of the luminaire must be higher than it would have to be if the pattern of illumination covered the angular or spatial range uniformly. Because the predetermined light output distribution rad_out(phi3) can be freely specified and achieved to a degree of fidelity illustrated below, lenses according to the above equations can produce light intensity distributions that avoid wastefully excessive central intensities. If a uniform light intensity distribution as a function of phi3 is needed then rad_out(phi3) is set equal to one in the above equations. If a flat area such as the floor of a room, desk or counter surface, is to be illuminated uniformly without wasteful excessive central intensity then rad_out(phi3) can be set to:

$$rad\_out ( φ3 ) = \frac{1}{{( cos ( φ3 ) )}^{e}} \qquad EQU . 10$$

where e is approximately equal to 3, e.g., 3.2, 3.5.

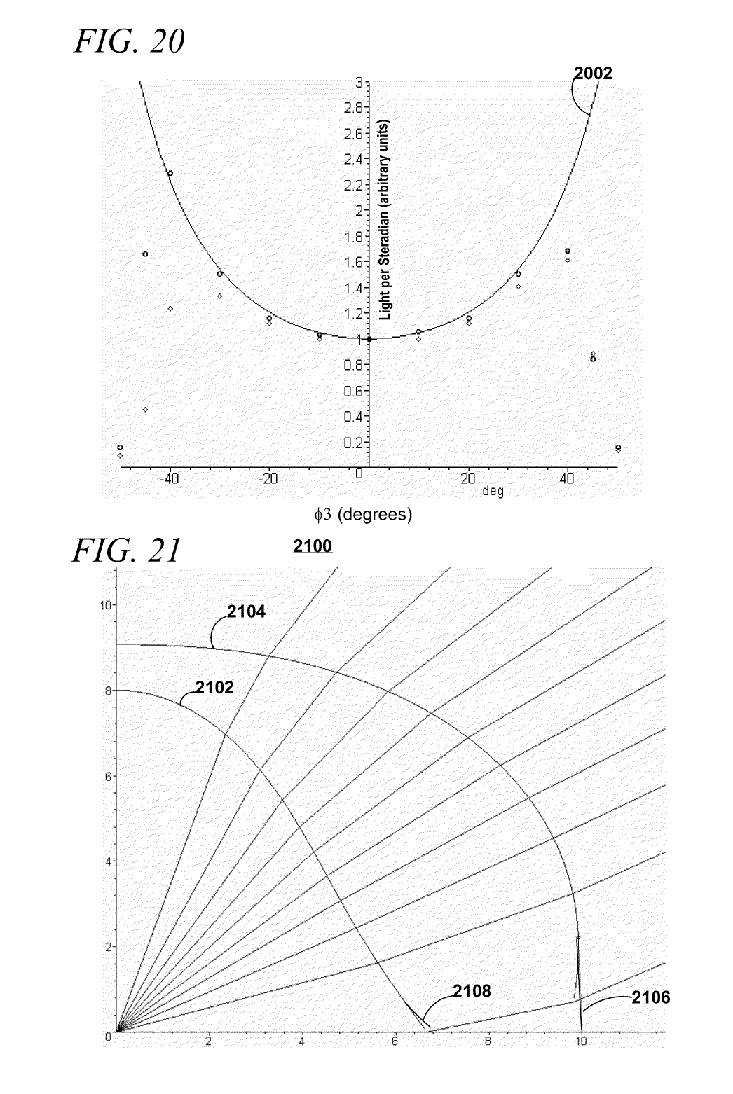

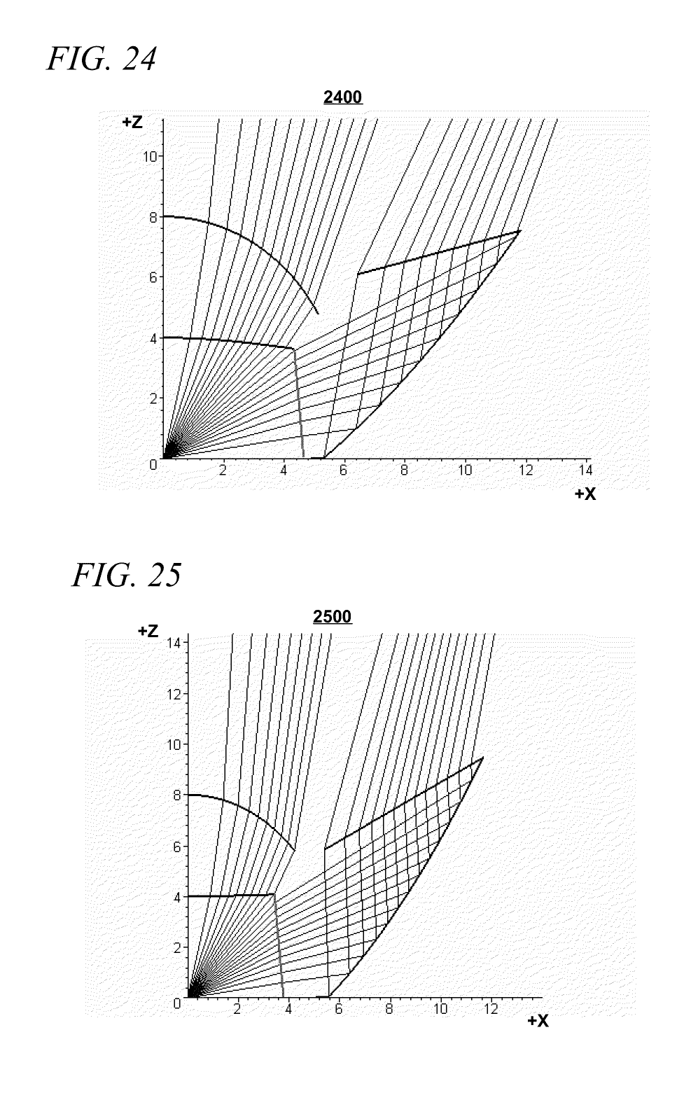

This distribution with e=3.0 is a theoretically known distribution and is shown as a plot 2002 in FIG. 20 for a phi3 range from zero to 45. This distribution is quite the opposite of the usual luminaire distribution which is peaked in the center. This distribution is lowest in the center and increases as the polar angle phi3 increases. The increase is about a factor of 2.8 at 45 degrees. More light is required at high values of phi3, because there is more area per phi3 increment as phi3 increases. Examples of lenses defined using the intensity distribution specified by EQU. 10 are shown in FIG. 15, FIG. 16, FIG. 18, FIG. 21, FIG. 23, FIG. 24 and FIG. 25. According to embodiments of the invention a higher fidelity to the distribution shown in FIG. 16 which is based on e=3 is achieved if e is slightly higher than 3 e.g. 3.2, 3.5. This is believed to be due to the fact that the finite size of the LED die causes a blurring effect (akin to an angular analog of a point spread effect, or apodizing effect) which leads to lesser variation than intended. This is compensated by increasing e in rad_out of the form given by EQU. 10. The amount that e should be increased can be determined by making a few prototype lenses using different values of e. For example one can start with a value of e=3 which will probably produce an actual rad_out distribution that is too weak a function, then one can try 3.5 and depending on whether the variation of the resulting distribution function is too strong or too weak one can then use a lower or higher value of e. The inventor has found that a few prototypes are sufficient to achieve acceptable fidelity to the intended distribution.

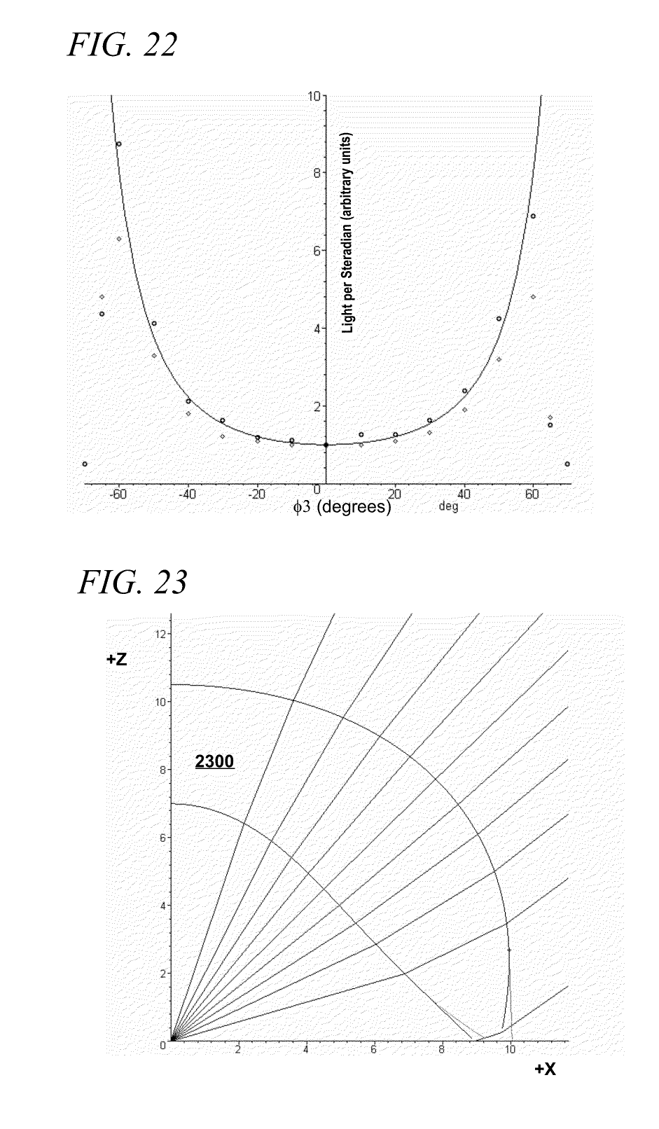

In FIG. 20 the data points denoted by diamonds are based on measurements of the actual rad_out light distribution produced by a prototype lens where rad_out in the equations was as given by EQU. 10 with e=3.0—the theoretical value. The data points denoted by circles are based on measurements of the actual rad_out light distribution of a second prototype lens based on a value of e=3.5. Generatrices of the second prototype are shown in FIG. 16 and information relating thereto is given in Table I above. As shown the data points for the second prototype points follow the target function more closely. The measurements were done using a white Luxeon III LED manufactured by Lumileds of San Jose Calif. There was an observed asymmetry in the placement of the LED die of the Luxeon III used for testing which may have led to the asymmetry of the measured rad_out distributions shown in FIG. 20 and FIG. 22. Numerous IES files of prior art luminaries were reviewed and none were found that matched EQU. 10 with e=3.0 to the degree achieved with the second prototype. FIG. 20 does not convey the striking visual impact that the inventor observed when these lenses were first tested. Arranging a single LED with one of the lenses on a table to illuminate the ceiling one sees a large clear uniform disk of light about 10 ft (3.05 meters) in diameter. It is strikingly unfamiliar even to a person familiar with a variety of modern light fixtures.

A more general way of correcting rad_out based on discrepancies between the intended rad_out function and the measured rad_out function is to first make a lens with rad_out set equal to the target distribution and measure the actual rad_out distribution achieved at a number of points, e.g., 10 points. Then, the data points are normalized so that the integrated light intensity represented by the data points is equal to the integrated light intensity of the same 10 points of the target distribution. Next point-by-point differences are computed between the normalized measurements and the target rad_out function. These differences are then added to the points of the target rad_out function to obtain a corrected set of points of rad_out. A spline fit of the corrected set of points is then used as rad_out and the differential equations reintegrated and a new lens made based on the new integration. (Alternatively rather that a spline fit an interpolating routine is used) This procedure can be done recursively. If one is inclined to rely on ray tracing then ray tracing can be used to evaluate each new lens rather than making actual prototypes, however the inventor has relied on prototyping.

If it is desired to avoid a sharp shadow at the edge of the illuminated area rad_out(phi3 given by EQU. 10 can be multiplied by a function that is constant over a substantial portion of the phi3 range, say up to 0.8 times phi3_max, and then tapers down gradually (e.g., linearly). In some cases edge effects that occur at phi3_max even without altering rad_out(phi3) may provide sufficient tapering of the light pattern edge.

In practice there may be as much to be gained in terms of pattern efficiency by using lenses according to the present invention as there is to be gained in terms of optical luminaire efficiency (i.e., the percentage of light generated in the luminaire that escapes the luminaire).

Additionally the lenses defined by the lens equations given above have smooth surfaces with a limited number of corners which means that the issue of light loss at numerous corners is avoided. Additionally having smooth surfaces with a limited number of corners, means that the molds to make the lenses and consequently the lenses themselves can be made more economically.

FIG. 21 shows generatrices of a lens 2100 defined by DE1, DE2, DE3 and designed to produce an output light distribution rad_out according to equation 14 with e=3.0. A portion of the outer surface 2104 was replaced by a constant draft 2106 section and a corresponding part 2108 of the inner surface 2102 was redefined by DE3. An adjustment of e to 3.2 in the equations defining the lens produced better fidelity to the intended light distribution pattern. Information for the lens shown in FIG. 21 is given in Table V.

TABLE V

| Phi1_MIN | 0.0 radians |
|---|---|
| Phi1_MAX | 1.57 radians (90 degrees) |
| Phi3_MIN | 0.0 radians |
| Phi3_MAX | 1.13 radians (65 degrees) |
| PhiD | −0.035 radians (−2.0 degrees) |
| Phi1_at_phiD | 1.41 radians (80.8 degrees) |
| rad_in(phi1) | FIG. 1 |
| rad_out(phi3) | cos(phi3)\hat{ }(−3.2) |
| | (highly uniform on plane) |
| r1_ini | 8.0 |
| r2_ini | 9.07 |
| n1 | 1.0 |
| n2 | 1.497 (PMMA) |
| Phi_start | Phi1_min |
| Calculated Transmission | 92.15% |

Note that r2_ini was selected using a 1^{st} order ODE shooting method to obtain a lens diameter of 20.0 mm. In particular, after each integration r2_ini was scaled by 10.0 divided by ½ the lens diameter, this being continued for a few iterations until the lens diameter was within an acceptable tolerance of 20.0 mm.

FIG. 22 shows data obtained with prototype lenses and the above mentioned Luxeon III LED. Diamond symbol data points are for a lens based on the e of EQU. 10 set to 3.0 (the theoretical value) and circle data points are for the lens 2100 for which e was set to 3.2. Note that high fidelity to the intended light distribution was achieved. Such a wide light distribution can for example be used for low bay lighting, or for indirect uplighting from a chandelier or torchiere. A “half lens” based on revolving the generatrix around only 180 degree could be used for sconce that mounted at 6′ (1.83 meters) produces more than the usual accent lighting by illuminating a large e.g. 4′ (1.22 meters) semicircle on an 8′ (2.4 meter) ceiling above the sconce. A small mirror could be placed behind the lens to confine the light emitted by the LED to the azimuthal range from 0 to 180 degrees.

FIG. 23 shows a lens 2300 that is similar to those shown in FIG. 15 and FIG. 22 but for which phi3_max is 55 and with rad_out defined by EQU. 10 having an exponent e=3.3. Table IV below gives information related to lens 2300.

TABLE VI

| Phi1_MIN | 0.0 radians |
|---|---|
| Phi1_MAX | 1.57 radians (90 degrees) |
| Phi3_MIN | 0.0 radians |
| Phi3_MAX | 0.960 radians (55 degrees) |
| PhiD | −0.035 radians (−2.0 degrees) |
| Phi1_at_phiD | 1.36 radians (78.2 degrees) |
| rad_in(phi1) | FIG. 1 |
| rad_out(phi3) | cos(phi3)\hat{ }(−3.3) |
| r1_ini | 7.0 |
| r2_ini | 10.5 |
| n1 | 1.0 |
| n2 | 1.497 (PMMA) |
| Phi_start | Phi1_min |
| Calculated Transmission | 91.09% |

FIG. 24 shows a lens 2400 that is similar to that shown in FIG. 18 but for which phi3_max is 25 degrees as opposed to 35. Table VII below gives information related to lens 2400.

TABLE VII

| Phi1_MIN | 0.0 radians |
|---|---|
| Phi1_MAX | 1.57 radians (90 degrees) |
| Phi3_MIN | 0.0 radians |
| Phi3_MAX | 0.436 radians (25 degrees) |
| Phi_draft | −0.087 radians (−5.0 degrees) |
| Phi_exit | −0.262 radians (−15.0 degrees) |
| Phi1_switch | 0.872 radians (50.0 degrees) |
| rad_in(phi1) | FIG. 1 |
| rad_out(phi3) | cos(phi3)\hat{ }(−3) |
| | (uniform on plane goal) |
| r1_ini | 4.0 |
| r2_ini | 8.0 |
| r2_w_ini | 14.0 |
| n1 | 1.0 |
| n2 | 1.497 (PMMA) |
| Phi_start | Phi1_min for DE1, DE2 |
| | Phi1_switch for DE5 |
| Calculated Transmission | 91.79% |

FIG. 25 shows a lens 2500 that is similar to that shown in FIG. 18 but for which phi3_max is 15 degrees as opposed to 35. Table VIII below gives information related to lens 2400.

TABLE VIII

| Phi1_MIN | 0.0 radians |
|---|---|
| Phi1_MAX | 1.57 radians (90 degrees) |
| Phi3_MIN | 0.0 radians |
| Phi3_MAX | 0.261 radians (15 degrees) |
| Phi_draft | −0.087 radians (−5.0 degrees) |
| Phi_exit | −0.523 radians (−30.0 degrees) |
| Phi1_switch | 0.698 radians (40.0 degrees) |
| rad_in(phi1) | FIG. 1 |
| rad_out(phi3) | cos(phi3)\hat{ }(−3) |
| | (uniform on plane goal) |
| r1_ini | 4.0 |
| r2_ini | 8.0 |
| r2_w_ini | 15.0 |
| n1 | 1.0 |
| n2 | 1.497 (PMMA) |
| Phi_start | Phi1_min for DE1, DE2 |
| | Phi1_switch for DE5 |
| Calculated Transmission | 91.4% |

Note that both phi_exit and phi1_switch were decreased relative to the lens shown in FIG. 18. In choosing these and other parameters one goal is the minimize the overall size. Another goal is maintain high overall transmittance.

FIGS. 16-19, 21, 23, 25 illustrate a variety light distributions. Light distributions for approximately uniformly illuminating plane areas with half-angles (phi3_max) ranging from 15 to 65 degrees in 10 degree increments are shown.

According to embodiments described above EQU. 1 specifies a monotonic increasing relation between phi3 and phi1, i.e., as phi1 increases so does phi3. According to alternative embodiments of the invention rather than using EQU. 1 the following alternative is used:

$$\frac{{\int }_{φ1\_ MIN}^{φ1} rad\_in ( φ1 ) \cdot 2 π \cdot sin ( φ1 ) d φ1}{{\int }_{φ1\_ MIN}^{φ1\_ MAX} rad\_in ( φ1 ) \cdot 2 π \cdot sin ( φ1 ) d φ1} = \frac{{\int }_{φ3}^{φ3\_ MAX} rad\_out ( φ3 ) \cdot 2 π \cdot sin ( φ3 ) d φ3}{{\int }_{φ3\_ MIN}^{φ3\_ MAX} rad\_out ( φ3 ) \cdot 2 π \cdot sin ( φ3 ) d φ3} \qquad EQU . 11$$

According to this alternative phi3 is a decreasing function of phi1. This alternative is generally not as good because it leads to higher average ray deflections (phi3−phi1) and thus more surface reflection losses. One possible use is in a lens that includes two or more portions including at least one defined using EQU. 1 and at least one defined using EQU. 11. For example a first portion of lens which covers a phi1 range from zero to an intermediate value of phi1 which bisects the light intensity output of the light source into two equal portions can be defined using EQU. 11 and a second portion of lens which covers a remaining phi1 range can be defined using EQU. 1. For both portions phi3_min can be set to zero and phi3_max to 45 degrees. Within both portions in the limit that phi1 approaches the intermediate value of phi1, the output ray angle phi3 will approach zero. Thus, the junctures between the surfaces at the intermediate angle can be continuous and smooth.

Whereas lenses defined using EQU. 1 or EQU. 11 serve to control the distribution of light flux (e.g., lumens per steradian), for some applications it is desirable to control the relation between phi3 and phi1 in a different way. In such cases rather than using EQU. 1 or EQU. 11 in integrating the lens equations one can use another relation, such as for example.

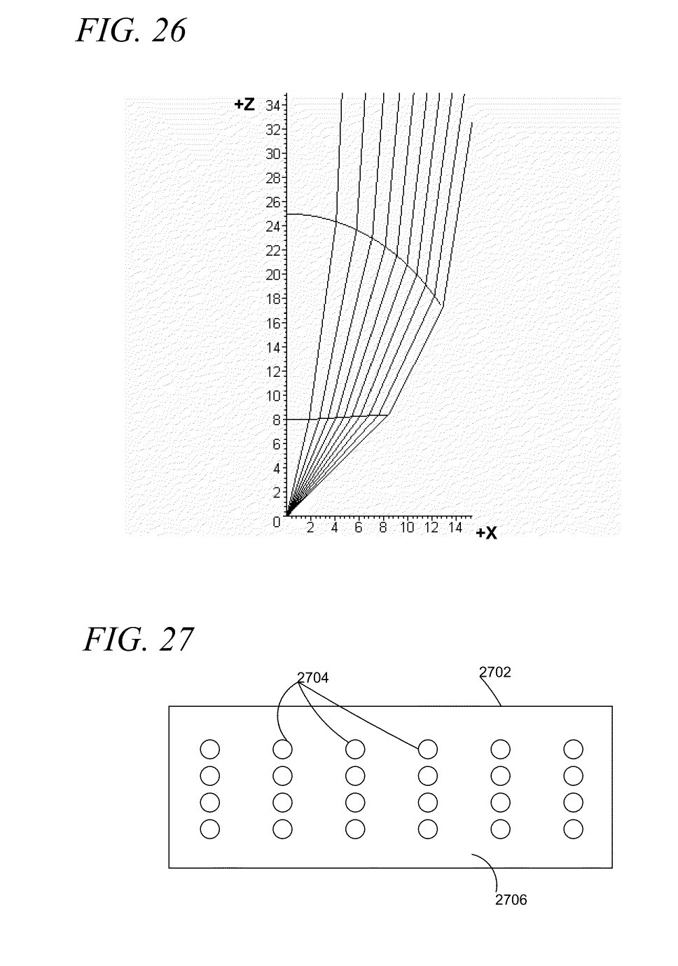

φ3=m·φ1 EQU. 12

where, m is a constant angular magnification factor.
FIG. 26 shows the X-Z coordinate system with generatrices of lens defined using phi3 giving by EQU. 12 with m=0.2 and DE1 and DE2.

FIG. 27 is a plan view of an LED based fluorescent replacement fixture 2702 that includes an array of the lenses 2704 (lead lines for only three are shown to avoid crowding the figure) defined by the differential equations given above. Each lens 2704 controls the light from a single LED chip or from a group of LED chips that are arranged close together, for example in a single LED package. The fixture also includes a power supply (not shown) for converting line power to power for the LEDs. The fixture may also include individual heat sinks (not shown) for each LED or LED package or a common heat sink. Heat sinks may be thermally coupled to a surface 2206 of the fixture in order to provide a larger area for dissipating heat.

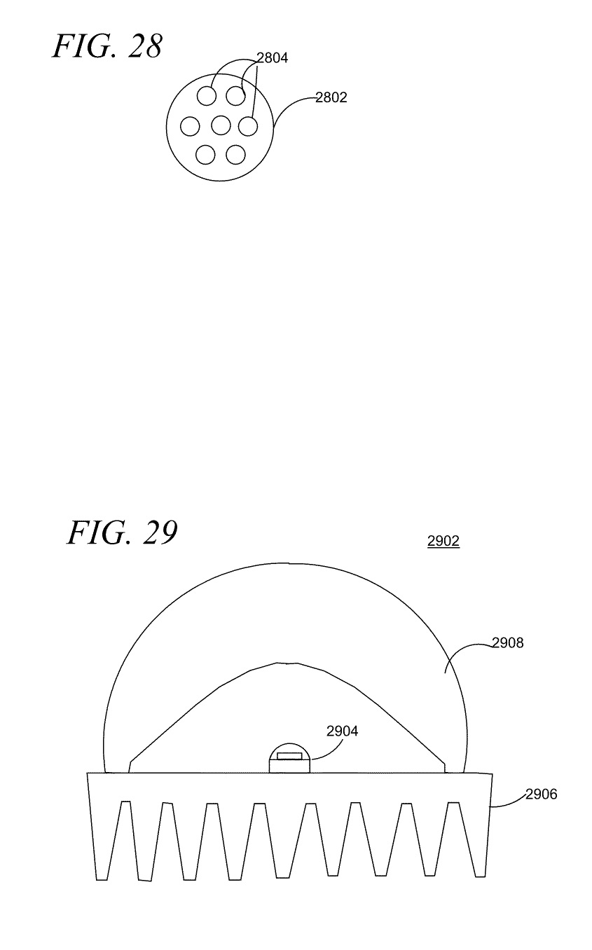

FIG. 28 is a plan view of a round (e.g., recessed, pendant, PAR replacement) lighting fixture 2802 that uses several of lenses 2804 defined by the differential equations given above (only three of which are numbered to avoid crowding the figure). Note that the lenses 2804 may or may not be recessed above the ceiling level. Recessed lighting fixtures are typically made in six and four inch diameter sizes. As in the preceding cases the fixture 2802 will also include a power supply not shown and a heat sink (not shown).

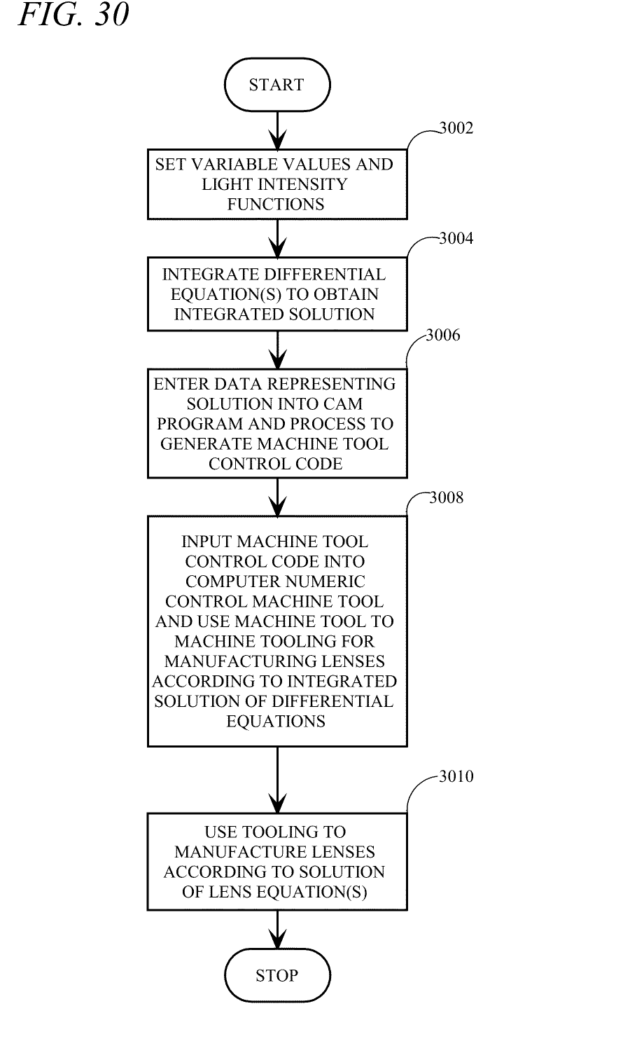

FIG. 29 shows a portion of an LED luminaire 2902. The luminaire 2902 includes a packaged LED 2904 mounted on a heat sink 2906. A lens 2908 defined by DE1, DE2 and DE3 is also mounted on the heat sink 2906. The lens 2908 is located around the LED 2904 with the LED located at the focal point (X-Z coordinate system origin) of the lens 2908. Alternatively, unpackaged LED chip could be used. Alternatively, a lens defined in part by DE4 and/or DE5 could be used.

FIG. 30 is a flowchart of a method 3000 of making lenses according embodiments of the present invention. In block 3002 the values of the variables and functions, as are listed in the tables above, are entered into a computer that is loaded with a differential equation integrator such the Runge Kutta routine, for example. In block 3004 a chosen subset of the differential equations DE1, DE2, DE3, DE4, DE5 are integrated to obtain an integrated solution. The integrated solution may be output as a series of points along each generatrix and optionally associated normal vectors for each point.

In block 3006 data representing the integrated solution is input in a Computer Aided Manufacturing (CAM) program and processed to generate machine tool control code.

In block 3008 the machine tool control code is entered into a Computer Numeric Control (CNC) machine tool used to machine tooling (e.g., mold inserts) for manufacturing lenses according to the integrated solutions. Although not shown in FIG. 30, the mold inserts will need to be hand polished (e.g., with a series of diamond pastes) before being used.

In block 3010 the tooling is used to manufacture lenses according to the integrated solutions.

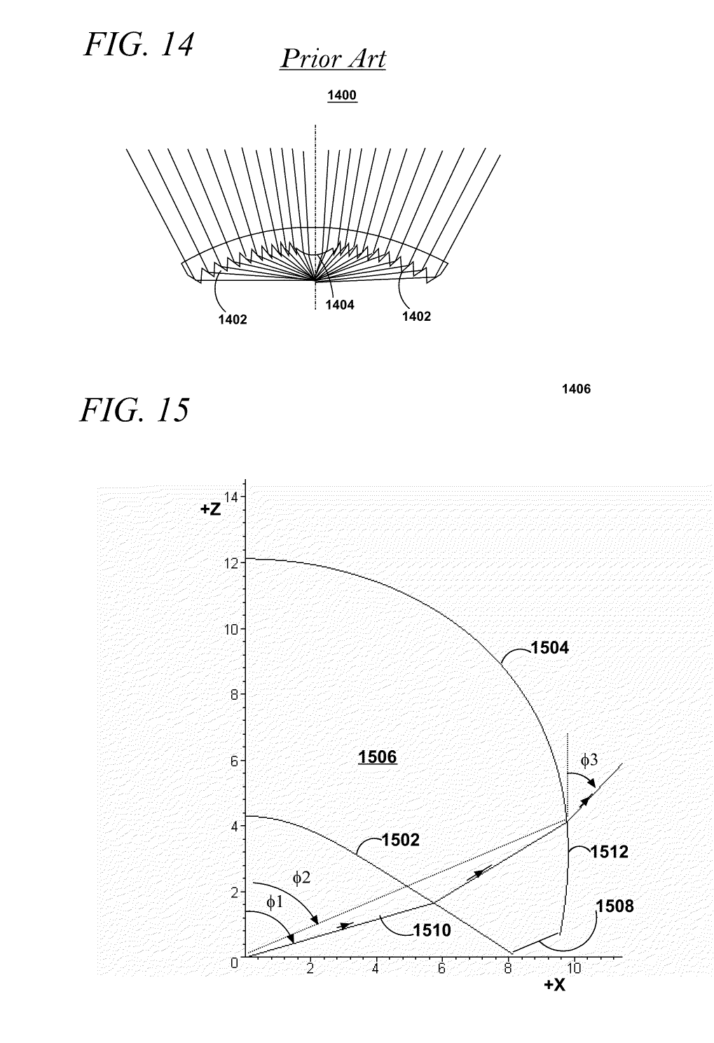

Because the surfaces of the lens have smooth surfaces with few corners monotonic injection molding molds to make them can easily be turned and polished. Thus one can easily and relatively inexpensively (e.g., compared to the case of FIGS. 7, 8, 9, 10, 14) make versions of the lens for each model of LED based on its light intensity distribution rad_in(phi1). Moreover, if a particularly useful LED exhibits significant unit-to-unit variations in the light intensity distribution rad_in(phi1) then the LEDs can be binned by light intensity distribution pattern and a version of the lens 1506 made for each bin. However, generally it will be sufficient to base rad_in(phi1) on an average of light intensity distributions for a particular light source.

As shown by plot 1304 in FIG. 13 light transmitted by the refractive lens (or refractive parts of lenses) described above drops off as the light ray deflection angle increase. While the light that is not transmitted may not be totally lost because it may ultimately scatter back out of the lens, control over the destination of the light will be largely lost due to the scattering. For a typical index of refraction of 1.5 at a deflection angle of about 45° the transmission is down to about 85%. While a design could push the deflection further there is a cost in terms of transmission loss. In the case of TIR surfaces the deflection by reflection is limited to twice the critical angle, which for an index of refraction of 1.5 twice the critical angle is 83.6°. A lighting class LED typically emits in a quasi-Lambertian pattern which has light distributed non-uniformly in a 2π hemispherical solid angle. For certain lighting applications, such as but not limited to the examples provided below and described in FIGS. 38-41, it is advantageous to restrict light output to azimuthally asymmetric solid angle ranges. Doing so can help keep light where it is needed and avoid wasting light. For example certain cities have dark skies initiatives which call for the restriction of upwardly directed light so as to reduce light pollution which has one benefit of making stars more visible at night. Also for roadway lighting it is desirable to distribute most of the illumination on the road and limit house-side illumination.

According to alternative embodiments rather than use surfaces defined by sweeping the generatrices defined above through a full 360°, the physical lenses are truncated. For example the physical lens can be truncated at the X-Z plane, and a mirror positioned at the X-Z plane. The mirror will form an image of the LED, reflect substantially all the light into a 180° azimuthal range and the lens 1506 will then redirect the light as described above but within a limited azimuthal range. Furthermore freeform lens which have surfaces that are not described by a rotated generatrix can also be limited to an azimuth range of less than 360° and a mirror can be used collect light in an angular range not subtended by the lens and reflect light to the lens.

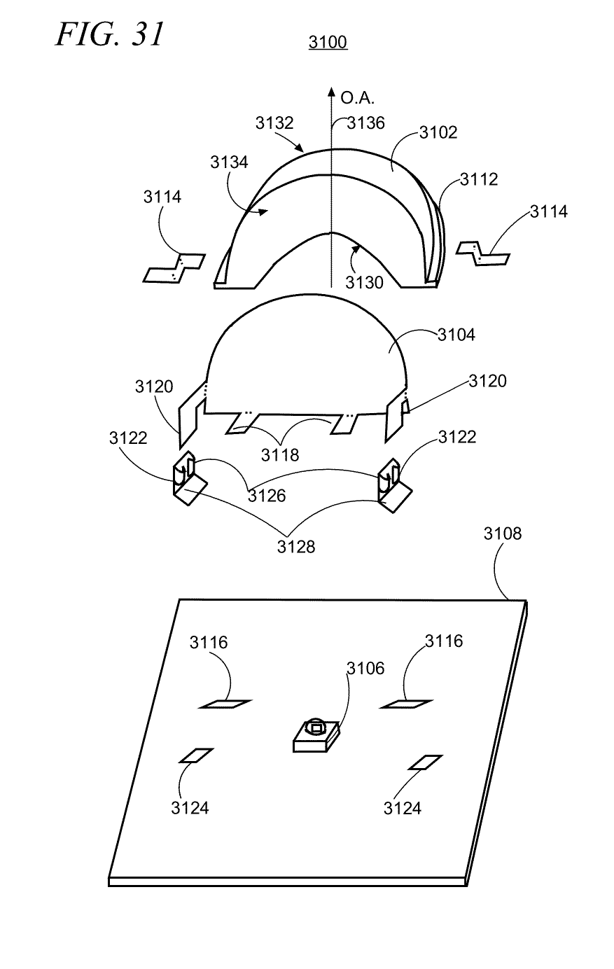

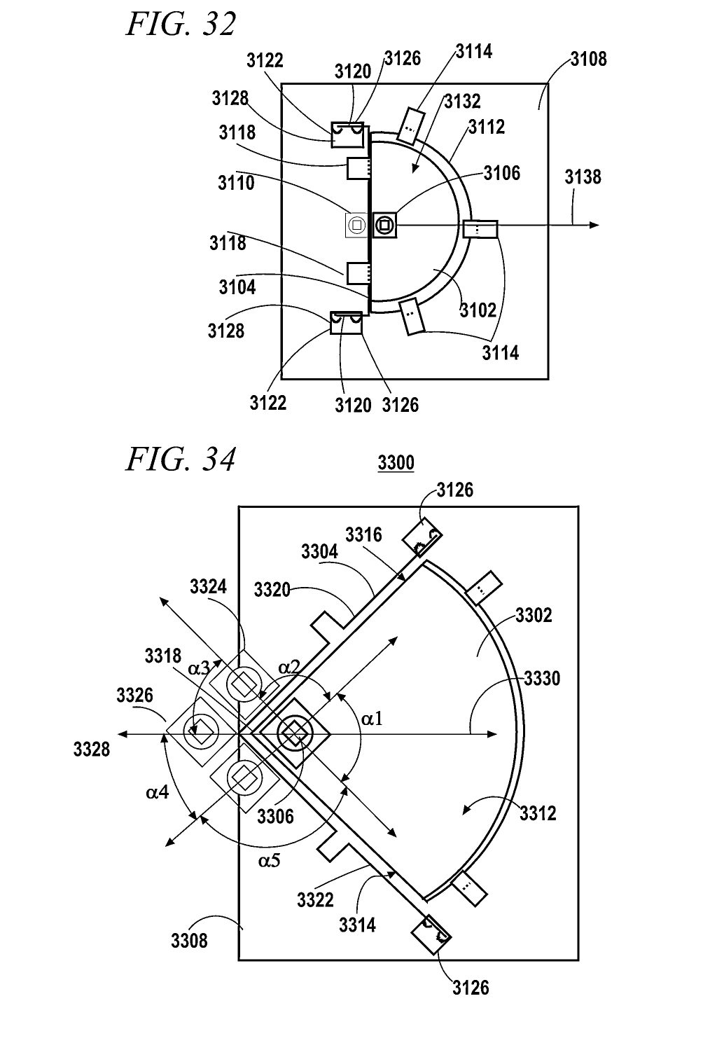

FIG. 31 is an exploded view of an LED illumination assembly 3100 that includes a half-lens 3102 and metal reflector (mirror) 3104 positioned about an LED 3106 on a circuit board 3108 and FIG. 32 is a top view of the assembly 3100 shown in FIG. 31. For applications in which it is desired obtain good control of the light distribution produced by the assembly 3100 the metal reflector 3104 is preferably specular as opposed to diffuse. A metal reflector has the advantage over a TIR surface in that the deflection angle is not limited to twice the critical angle. Because of this the metal reflector 3104 positioned directly adjacent to and LED can reflect all of the light incident on it, even light incident at angles below what would be the critical angle for a TIR optics. The metal reflector 3104 forms an image 3110 of the LED 3106, such that the optical center of illumination from the point of view of the half-lens 3104 is a point on the metal reflector 3104 between the LED 3106 and its image 3110. Additionally front surface sheet metal reflector, in contrast to a back surface metalized (silvered) glass mirror, by virtue of reflecting at the surface limits the growth of the optical source size of the effective combined real and image source seen by the half-lens. The optical source size is certainly increased but by far less than it might in other arrangements that comparably reduce the angular extent of light radiated by an optical system while comparably controlling light loss. In the interest of efficiency the reflectivity of the metal reflector is preferably high. Anodized aluminum or silver coated metal may be used. Generally speaking silver has the highest visible light reflectance and is therefore silver plated sheet metal is a good choice for the metal reflector 3104 and other reflectors disclosed herein. Among the commercially available highly reflective sheet metals products that can be used to make the metal reflector 3104 and other metal reflectors disclosed herein are those made by ALANOD-WESTLAKE Metal Industries, Inc. of North Ridgeville, Ohio, including Miro® and Miro Silver®. Miro Silver® is reported to have a reflectance of 98%. In most instances it is advantageous to have a protective coating over highly reflective metal surfaces to avoid degradation, and the Miro® products do have protective coatings. Alternatively a silvered (or other reflective coating) back surface mirror could be used but if so the transparent substrate on which the reflective coating is formed is preferably thin to limit the distance of the image of the LED and thereby limit the optical source size of the combined LED object/image source. The reflective surface is preferably placed within 1.0 mm of the LED, for example, right up against the LED package or a few mils (increments of 25.4 microns) away. Use of a reflector leads to an effective doubling of the optical source size in one dimension which leads to some blurring of the pattern produced by the half-lens 3102, compared to what would be obtained with a ideal point source nonetheless beneficial illumination control is obtained by using the metal reflector 3104 half-lens 3102 combination.

The half-lens 3102 includes an inner surface 3130 facing the LED 3106 and an outer surface 3132. One or both of the surfaces 3130, 3132 is designed to refract light so as to redistribute the light. The inner surface 3130 receives a first portion of light directly from the LED 3106 and receives a second portion of light that is emitted from the LED 3106 and reflected by the metal reflector 3104 before reaching the inner surface 3130.

The half-lens 3102 also includes a planar surface 3134 that is coincident with a virtual cut plane of the half-lens 3102 and extends between the inner surface 3130 and the outer surface 3132. Although it can be said that the half-lens 3102 has a virtual cut plane, this is not to say that it need be manufacturing by cutting a whole lens in half, rather it can be molded as a half lens. To the extent that there need not be an index matching material between the planar surface 3134 and the metal reflector 3104 (although this possibility is not excluded) and to the extent that the metal reflector 3104 is not pressed into intimate contact with the planar surface 3134 (also not excluded), and because of the finite size of the optical source embodied by the LED 3106, the planar surface 3134 may act as a TIR surface for a small portion of light emitted by the LED 3106 which is emitted at angles close to the metal reflector 3104, is refracted through inner surface at an angle heading to the planar surface 3134, is incident on the planar surface 3134 at a glancing angle, and is then reflected by the planar surface 3134 to the outer surface 3132 through which it is refracted.

Note that the half-lens 3102 includes an integrally molded flange 3112. A pair of stamped sheet metal reflow solderable lens holders 3114 are soldered to solder pads 3116 on the circuit board 3108 and engage the flange 3112 holding the lens 3102 in position on the circuit board 3108. The reflow solderable lens holders 3114 are taught in the applicant's co-pending U.S. Published Patent Application No. 20120268957 entitled Reflow solderable, surface mount optic mounting. The metal reflector 3104 includes two feet portions 3118 located at the bottom (in the perspective of FIG. 31) of the metal reflector 3104 that are bent at 90° so as to be parallel to and resting on the board 3108. These two feet portions 3118 help to support the metal reflector 3104. Although as shown they are both bent one way, alternatively they are bent in opposite directions. The metal reflector 3104 also includes two right-angle tab portions 3120 that extend from the sides of the metal reflector 3104 and are bent by 90° from the plane of the main portion of the metal reflector 3104. The right-angle tab portions 3120 engage in mating surface mount female spade connectors 3122 that are soldered on solder pads 3124 on the board 3108. The use of the reflow solderable lens holders 3114 and the surface mount female spade connectors 3122 allows the alignment of the half-lens 3102 and the metal reflector 3104 with the LED 3106 to be established in the course of using a pick-and-place machine to place the preceding components on precisely positioned solder pads on the circuit board 3108. An additional advantage of using the reflow solderable lens holders 3114 and the surface mount female spade connectors 3122 is that the half-lens 3102 and the metal reflector 3104 need not be put through the high temperature e.g., 260 C.° reflow solder process which could damage their optical surfaces. This also allows the half-lens 3102 to be made out of thermoplastic materials such as polycarbonate or PMMA which have maximum service temperatures of about 100 C.° or less. Once the solderable lens holders 3114 and the surface mount female spade connectors 3122 are soldered in place the half-lens 3102 and mirror 3104 can be engaged with them. Alternatively, the metal reflectors 3104 could be soldered in place, for example, by soldering the feet portions 3118 to appropriately repositioned solder pads 3124.

Looking particularly at the surface mount female spade connectors 3122 it is seen that they have a female engaging portion 3126 that engages with the right-angle tab portions 3120 of the metal reflector 3104 and solderable feet 3128 extending from the engaging portion 3126. While the female engaging portion 3126 is of a type known in the art of electrical wire terminals, the surface mount version such as disclosed herein may not be known and it is believed that the adaptation for holding a small metal mirror on a printed circuit board is new. Because the reflector 3108 is made from sheet metal, it is alternatively possible to form the female engaging portion 3126 integral to the reflector 3108 and make the use a simple surface mount male spade therewith. It is also possible to adapt other styles of mating electrical connector contacts for the purpose of holding the metal reflector 3104 on the circuit board 3108.

The metal reflector 3104 confines light emitted by the LED to an azimuthal range that is a somewhat greater than 180°. In particular it is greater by approximately:

$$θ sub = 2 * arctan ( 2 * \frac{d}{M} )$$

Where d is the perpendicular distance from the metal reflector 3108 to the side of the LED chip in the LED 3106 that is furthest from the metal reflector 3104, M is the width of the metal reflector 3104. For a typical 1 watt power LED that has a square package 2.5 mm to 3.5 mm wide and a 0.7 to 1.4 mm wide square chip, d ranges from 1.55 to 2.45. A typical value for M might be 10 mm. The inner surface 3130 and the outer surface 3132 subtend azimuth angle ranges less than 360°, in particular azimuthal angle ranges about equal to θsub defined above. The shape of the half-lens 3102 can be changed from the surface of revolution shape shown in FIG. 31 to a shape that changes the azimuthal spread of light so that the azimuthal spread of light can be made less than 180° by refraction as well. Having both the metal reflector 3104 and the half-lens contribute to determining the azimuthal spread is not excluded.

The LED illumination assembly 3100 has an optical axis 3136 which extends from the center LED 3106 upward perpendicular to the LED die surface and perpendicular to the circuit board 3108 as well. An ‘azimuthal central axis’ 3138 is also defined. The azimuthal central axis extends from the center of the LED parallel to the LED die surface and parallel to the circuit board in a direction that bisects the azimuthal angular range that is illuminated by the assembly.

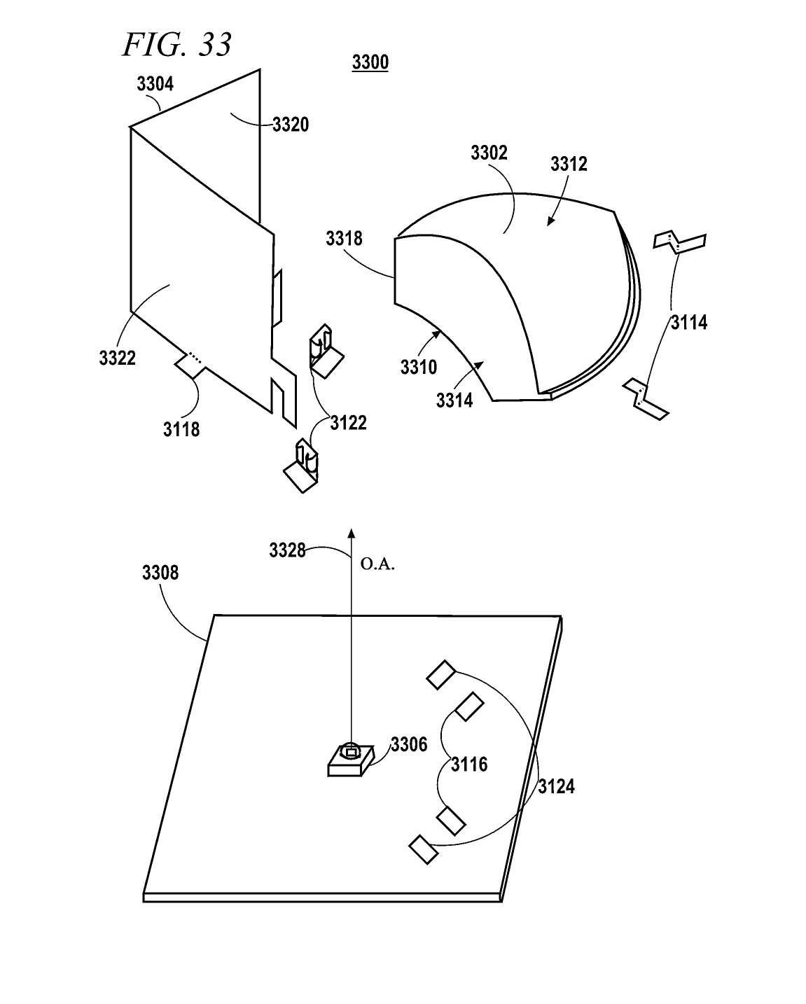

FIG. 33 is an exploded view of an LED illumination assembly 3300 that includes a quarter-lens 3302 and a right angle bend metal reflector 3304 positioned about an LED 3306 on a circuit board 3308 and FIG. 34 is a top view of the assembly 3300 shown in FIG. 33.

The quarter-lens 3302 includes an inner surface 3310, an outer surface 3312 which are connected by a first planar surface 3314 and a second planar surface 3316. The two planar surfaces 3314, 3316 are oriented at right angles to each other and meet at a vertex 3318. As a practical matter the junction of the two planar surfaces 3314, 3316 is not atomically sharp and the juncture of the two planar surfaces may include a designed-in chamfer. The planar surfaces 3314, 3316 can be tilted at a small draft angle to facilitate mold ejection, however alternative mold arrangements in which the planar surfaces are not anywhere near perpendicular to the mold parting plane are also possible.

The metal reflector 3304 includes a first half 3320 and second half 3322 which meet at the aforementioned right angle bend. Hence the metal reflector 3304 subtends and azimuth angle of about 270° around the LED 3306. The azimuthal subtense is slightly below 270° due to the finite size of the LED 3306. The two halves 3320, 3322 are planar. Adapting language used to describe mathematical functions, it can be said that optically utilized portion of the metal reflector 3304 is ‘piecewise planar’. In the assembly, the first half 3320 of the metal reflector 3304 and the second half 3322 of the metal reflector 3304 are positioned in close proximity to the first planar surface 3314 and the second planar surface 3316 respectively of the quarter-lens 3302, preferably within 1.0 mm or in actual contact. For any sheet metal out of which the metal reflector 3304 may be formed there is typically a minimum bend radius and aforementioned chamfer at the vertex 3318 of the quarter-lens 3302 can be designed to match the minimum bend radius. The bend radius at the juncture of the two halves 3320, 3322 of the metal reflector has some though not great significance arising from close proximity of the juncture to the LED. For example the metal reflector 3304 can be made 0.25 mm sheet metal with a 0.25 mm minimum bend radius, and for a very small 2.5 mm square LED package the 0.25 mm bend would subtend an azimuth angle of 11.4° from the center of the LED, which is small compared to 270° which is about the azimuth range subtended by the metal reflector 3304. For the more common 3.5 mm square LED the bend would subtend a smaller angle, however on the other hand the effective optical source size would be greater. According to certain embodiments the bend radius measured at the inside of the bend is less than 1.0 mm. According to certain embodiments the bend radius measured at the inside of the bend is less than 2.0 the thickness of the material out of which the metal reflector 3304 is made. In this specification if the bend radius measured at the inside of the bend is set at less than 2.0 times the thickness of the metal reflector 3304, the bend radius is considered inconsiderable in so far as the optically utilized portions of metal reflector will be termed ‘piecewise planar’. Certain parts of the metal reflector 3304 are not part of the optically utilized portions in that they do not reflect light. For example feet 3118 are not part of the optically utilized portions of the metal reflector 3304.

To eliminate the bend radius one can make the metal reflector 3304 in two pieces. FIG. 37 shows a metal reflector 3702 that can be used as one of a two mirror set in lieu of the metal reflector 3304. The other mirror in the set which is not shown would be the mirror image part. FIG. 37 shows the back of the metal reflector so that the reflective surface is facing away from the observer. The metal reflector includes a first mounting tab 3704 that is integrally formed at the lower right hand corner and second mounting tab 3706 that bends backward and down from the top edge. These mounting tabs engage with surface mount spade connectors 3122 discussed above. Arranging the second mounting tab 3706 emanating from the top edge leaves an uninterrupted left side edge that can be engage with the mirror image part (not shown in a v-configuration mimicking the shape of the right angle bend reflector 3304 but avoiding the issue of the finite bend radius.

Another alternative is to intentionally set the bend radius equal to the distance from the LED 3306 center to the corner of the LED package or preferably no more than 1.0 mm beyond the corner. Alternatively the bottom of the bend could be notched out so that the metal reflector 3304 would fit over LED package substrate (chip carrier) and in the case of an LED with a silicone dome, the radius of the bend could be as small as the radius of the silicone dome. One might also create very shallow notch portions on the bottom of the metal reflector 3304 near the LED 3306 that are a few mils (increments of 25.4 microns) high so as to avoid the bottom edge of the metal reflector 3304 pressing against solder mask protected traces on the surface of the circuit board that supply power to the LED 3306. The height of the very shallow notches can be kept lower than the height of the LED package substrate (chip carrier). Alternatively the traces can follow a path that does not cross under the metal reflector 3304.

Setting aside the issue of the bend radius we turn to matter of the optical consideration of the assembly 3300 as shown in FIG. 33. Light in a first 90° azimuthal angular range denoted α1 is emitted through the quarter-lens 3302 without reflection by the metal reflector 3304. Light in a second 90° azimuthal angular range denoted α2 is reflected by the first half 3320 of the metal reflector 3304 forming a first image 3324. The light emitted in the second angular range α2 exits the assembly 3300 after a single reflection by the metal reflector 3304. Light in the second 90° azimuthal angular range denoted α2 is uniformly redistributed over the first 90° azimuthal angular range dentoted α1.

Light emitted in a third angular 45° range α3 is reflected twice—once by the first half 3320 of the metal reflector 3304, then by the second half 3322 of the metal reflector 3304 and then exits through the quarter-lens 3302. The second reflection forms a second image 3326 which is an image of the first image 3324 in the second half of the 3322 of the metal reflector 3304. Light in the third 45° azimuthal angular range denoted α3 is uniformly redistributed over an upper half of the first 90° azimuthal angular range α1. Light emitted in a fourth 45° range α4 is analogous to the light emitted in the third angular 45° range α3. Light emitted in a fifth 90° range α5 is analogous to the light emitted in the second angular 90° range α2. In the case that the mirror halves 3320, 3322 are planar, they uniformly redistribute light in the angular ranges α2-α5 over the angular range α1. From the point of view of the quarter-lens the plan view (perspective of FIG. 34) location of the vertex 3318 corresponding to the juncture of the halves 3320, 3322 can be treated as the optical source center for the purpose of establishing the shapes of the lens surfaces 3310, 3312.

The illumination assembly 3300 has an optical axis 3328 and an azimuthal central axis 3330 (defined above).

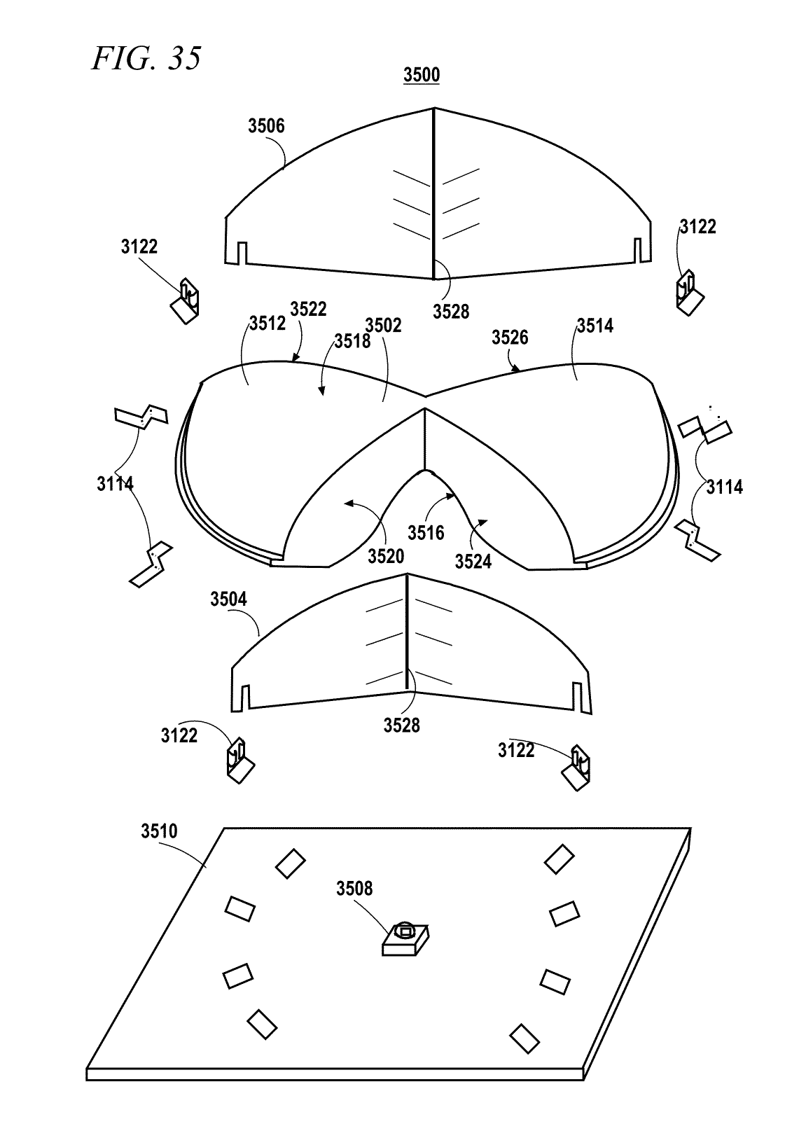

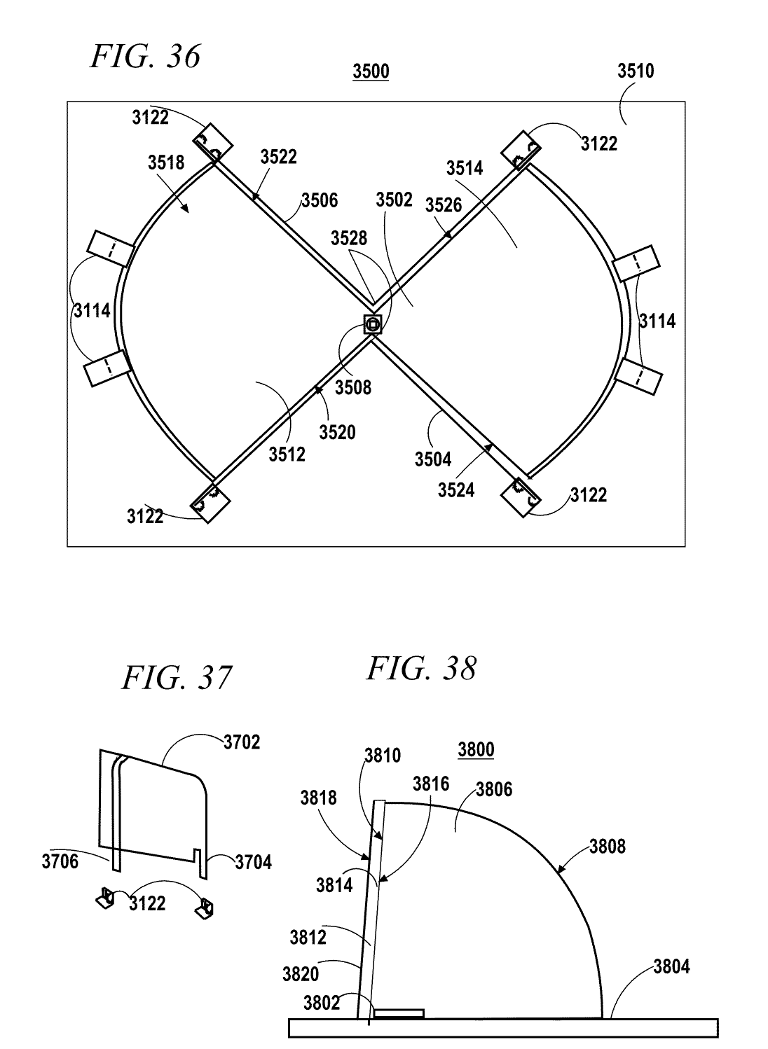

FIG. 35 is an exploded view of an LED illumination assembly 3500 that includes a two sector lens 3502 and a metal reflector set 3504, 3506 positioned about an LED 3508 on a circuit board 3510 and FIG. 36 is a top view of the assembly 3500 shown in FIG. 35.

The two sector lens 3502 lens includes a first sector 3512 and a second sector 3514 siamesed together. The two sector lens 3502 is akin to two quarter lenses 3302 joined together, with the notable difference in that there would be no double reflection leading to an image of an image as in the case of second image 3326. The two sector lens 3502 includes an inner surface 3516 and an outer surface 3518 that are joined by four side surfaces 3520, 3522, 3524, 3526. A first side surface 3520 and a second side surface 3522 are on opposite sides of the first sector 3512. Similarly a third side surface 3524 and a fourth side surface 3526 are on opposite sides of the second sector 3514

The metal reflector set includes a first metal reflector 3504 and a second metal reflector 3506 positioned on opposite sides of the lens. Each of the metal reflectors has a bend 3528 down the middle defining two halves. The halves of the metal reflectors 3504, 3506 (four in total) are located close to, preferably within 1.0 mm or up against the side surfaces 3520, 3522, 3524, 3526 of the two sector lens 3502. The optically utilized portions of the metal reflectors 3504, 3506 are piecewise planar.

The LED illumination assembly includes an optical axis 3512 and two separate ‘sector azimuthal central axes’ 3514, 3516 on for each sector 3512, 3514 of the two sector lens 3502. Note that the ‘azimuthal central axis’ as defined above does not apply to the assembly 3500 because due to the symmetry there is no unique azimuth angle the bisects the angular range illuminated by the assembly.

The two sector lens 3502 is suitable for roadway lighting application where the width of the road, the mounting height and the pole spacing dictate an illumination pattern whose width (across the road) is much shorter than its length (along the road), i.e., a high aspect ratio illumination pattern. In that application the azimuthal central axes 3514, 3516 are aligned parallel to the roadway.

While FIGS. 31-32 show the secondary half-lens 3102, alternatively a primary half-lens can used with the metal reflector 3104. FIG. 38 shows an optical assembly 3800 that includes an LED die 3802 mounted on a substrate 3804 (e.g., a printed circuit board, ceramic substrate). A primary half-lens 3806 is formed over the LED die 3802. The primary half-lens 3806 included a curved refractive surface 3808 and a tilted planar back surface 3810. The primary half-lens 3806 can for example be made of silicone elastomer. Alternatively the primary half-lens 3806 can have a hard outer shell made of, for example transparent plastic, and soft inner core, made of for example silicone gel. A reflector (mirror) 3812 includes a transparent substrate 3814 that includes a front surface 3816 and a back surface 3818. The transparent substrate 3814 can for example comprise glass, transparent plastic or crystal (e.g., sapphire). The front surface 3816 is in contact with the tilted planar back surface 3810 of the primary half-lens 3806. A reflective metal (e.g., silver) layer 3820 is deposited on the back surface 3818 of the mirror 3812. A protective coating (not shown) can be deposited over the reflective metal layer 3818.

The primary half-lens 3806 with mirror 3812 attached can be made by cavity molding. First the LED die 3802 is mounted on the substrate 3804 by conventional methods. Then a reusable cavity mold that is the negative shape of the primary half-lens 3806 with mirror 3812 is made. Next the mirror 3812 is cleaned (e.g., with alcohol and is placed in the cavity. Other surface preparation methods appropriate to the substrate can be used, such as for example UV, ozone or oxygen plasma activation. Next a quantity of silicone sufficient to form the half-lens 3806 is dispensed into the cavity mold. Next the substrate 3804 with LED die 3802 are placed upside-down in position over the cavity mold filled that has been with silicone and then the silicone is cured according to its requirements, e.g., at room temperature or at an elevated temperature. Thereafter the substrate is pulled away from the cavity bringing along with it the optical assembly 3800. According to certain embodiments the indices of refraction of the transparent substrate 3814 and the material out of which the half-lens 3806 is made (e.g., silicone) are matched, preferably within 0.2, more preferably within 0.1 and even more preferably within 0.05, but the front surface 3816 of the substrate 3804 which will bond to the primary half-lens 3806 is textured (roughened) to aid in adhesion of the front surface 3814 to the half-lens 3806. To the extent that the indexes of refraction are closely match, scattering by the textured adhesion promoting surface is reduced.

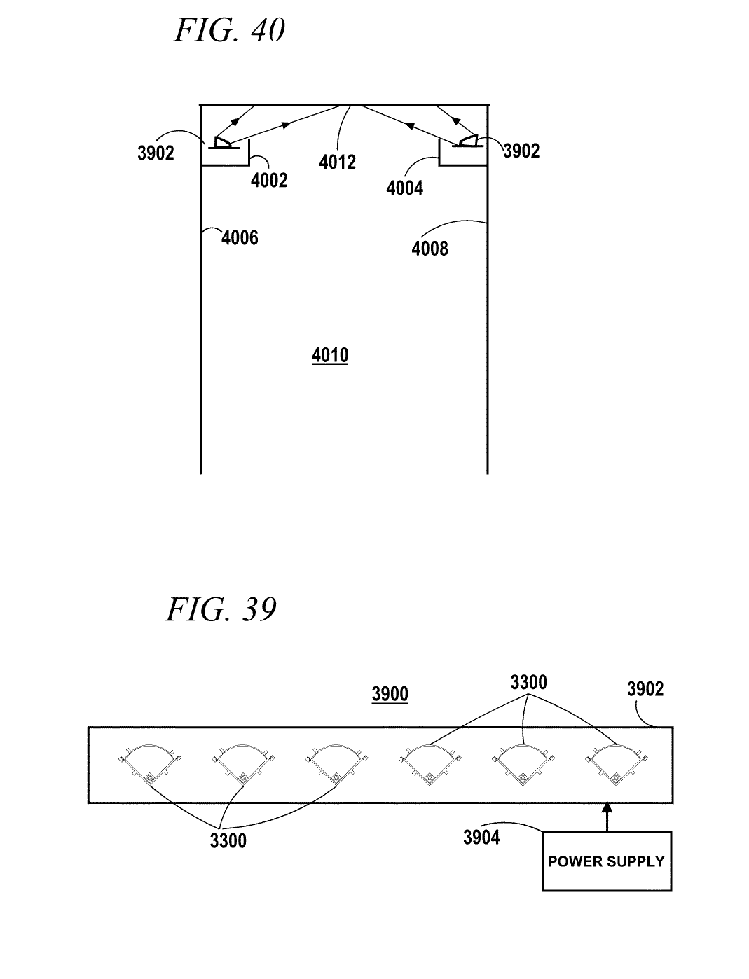

FIG. 39 shows a strip form factor cove luminaire 3900 using a set of the illumination assemblies 3300 with quarter-lenses 3302 arranged in a row on a metal core printed circuit board 3902. A separate LED power supply 3904 is connected to the metal core printed circuit board 3902. FIG. 40 is a schematic of an installation of the cove luminaire 3900 shown in FIG. 39. Two units of the cove luminaire 3900 are shown installed in two coves 4002, 4004 located on two walls 4006, 4008 on opposite sides of a hallway 4010 below a ceiling 4012. Traditional cove luminaires, which may for example be based on linear fluorescent tubes would not project the light uniformly on the ceiling. Also a significant portion of light from fluorescent tubes would scatter about in the cove and be lost by absorption without ever illuminating the ceiling 4012 or hallway 4010. For the cove luminaire 3300 one can choose phi3_min (see definition of EQU. 1 above) to a non-zero value such as 45° to greatly reduce the phenomenon of light being scattered around inside the cove and lost be absorption. Light emanating from the cove luminaires 3300 and illuminating the ceiling is represented by four light rays 4014 in FIG. 40. The metal reflector 3304 and the quarter-lens 3302 with phi3_min set to a non-zero value such as 45° will greatly reduce the amount of light that scatters around inside the coves 4002, 4004.

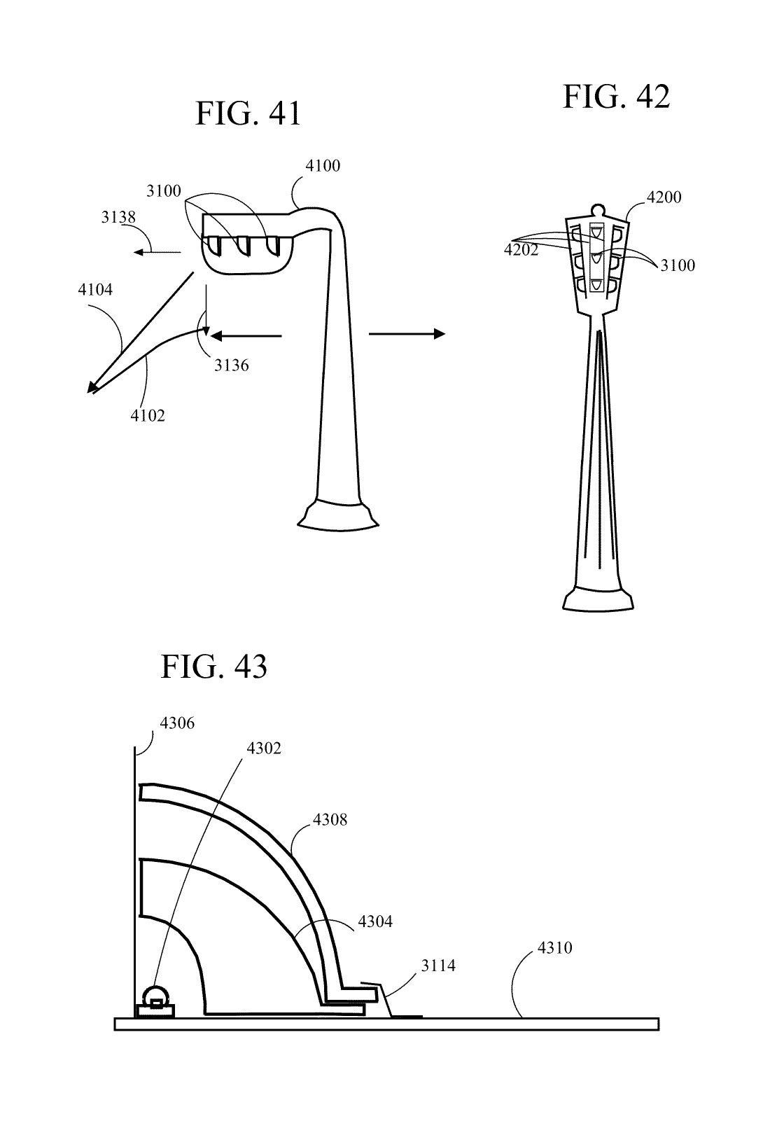

FIG. 41 shows an application of the LED illumination assembly 3100 shown in FIGS. 31-32 in a roadway luminaire 4100. Note optical design of a roadway luminaire 4100 shown in FIG. 41 is different from that described in the context of two quadrant lens shown in FIG. 35. The roadway luminaire 4100 uses multiple assemblies 3100 with half-lenses 3102. The assemblies 3100 are mounted facing downward within the luminaire, such that the optical axes 3136 faces downward, and the azimuthal central axes 3138 faces toward a roadway side of the luminaire 4100, as opposed to a sidewalk side. A luminous intensity distribution 4102 and a cutoff angle are schematically represented. One could orient a subset of the azimuthal central axes toward the sidewalk side if desired, however generally the requirement is to direct most of the light flux onto the roadway side.

FIG. 42 shows an application of the LED illumination assembly 3100 in an acorn style outdoor area luminaire 4200. In this embodiment the multiple assemblies 3100 are mounted on multiple metal core printed circuit boards 4202 which are mounted vertically or slightly tilted down and facing in different azimuthal directions about the luminaire 4200. The optical axes 3136 of the assemblies thus face radially outward from the luminaire 4200 and the azimuthal central axes 3138 of the assemblies 3100 point toward the ground. This arrangement provides for the traditional acorn luminaire style to be used without suffering the usual drawback of substantial light pollution due to substantial upwardly directed light.

FIG. 43 is cross sectional side view of a LED illumination assembly 4300 including an LED 4302, a half-lens 4304 positioned over the LED 4302, a metal reflector 4306 positioned on one side of the LED 4302, and remote phosphor half-dome 4308 positioned over the half-lens 4304 on a metal core printed circuit board 4310. The half-lens 4304 subtends a little more than 180° of the azimuthal range about the LED 4302 and the metal reflector 4306 subtends a remaining portion of the azimuthal range. Alternatively one could provided a remote phosphor quarter-dome over the quarter-lens 3302 in the embodiment shown in FIGS. 33-34. A full phosphor dome positioned over a lens which is positioned over an LED is taught in the applicants co-pending U.S. patent application Ser. No. 13/626,780, filed 25-SEP-2012 entitled LED Remote Photoluminescent Material Package.

While partial (e.g., half, quarter, sector) refractive lenses are shown in embodiments in FIGS. 31-43, alternatively partial hybrid refractive/TIR lenses analogous to the lenses shown in FIGS. 18-19 may be used in combination with metal reflectors such as shown in FIGS. 31-43.

Alternatively, a surface relief pattern can be added to one or more of the surfaces of the lens in order to provide a degree of diffusion, in this case the large scale profile of the lens surfaces 1502, 1504 is described by the equations given above, but there is a short scale, small amplitude variation added to the lens surface profiles.

As used herein the term ‘metal reflector’ includes a sheet metal reflector and a metal film deposited on a non-metal substrate.

Although the preferred and other embodiments of the invention have been illustrated and described, it will be apparent that the invention is not so limited. Numerous modifications, changes, variations, substitutions, and equivalents will occur to those of ordinary skill in the art without departing from the spirit and scope of the present invention as defined by the following claims.

What is claimed is:

1. An optical assembly comprising:
an LED;
a lens having a refractive surface that subtends a first portion of a 360° azimuthal range around the LED that is less than 360°;
a metal reflector that subtends a second portion of the 360° azimuthal range around the LED that is distinct from said first portion.

2. The optical assembly according to claim 1 wherein said first portion and said second portion encompass the entire 360° azimuthal range about the LED.

3. The optical assembly according to claim 1 further comprising a partial remote phosphor dome located over the lens.

4. The optical assembly according to claim 1 wherein said metal reflector comprises sheet metal.

5. The optical assembly according to claim 4 wherein said metal reflector comprises a mounting portion.

6. The optical assembly according to claim 5 further comprising:
a circuit board and a surface mount reflow solderable mounting device soldered to said circuit board said surface mount reflow solderable mounting device having an engaging portion adapted to engage said mounting portion of said metal reflector.

7. The optical assembly according to claim 5 further comprising a circuit board wherein said mounting portion of said circuit board is directly soldered to said circuit board.

8. The optical assembly according to claim 1 wherein said metal reflector is spaced from said LED by less than 1.0 mm

9. The optical assembly according to claim 8 wherein said metal reflector includes two flat portions.

10. The optical assembly according to claim 8 wherein said metal reflector comprises a bend proximate said LED and has two flat surfaces on opposite sides of said bend.

11. The optical assembly according to claim 10 wherein said bend has a radius that is less than 1.0 mm.

12. The optical assembly according to claim 1 wherein said lens comprises a half-lens and said metal reflector is planar.

13. A roadway luminaire comprising the optical assembly of claim 1.

14. A cove luminaire comprising the optical assembly of claim 1.

15. The optical assembly according to claim 1 wherein said lens is a primary lens and said metal reflector is a coating on a transparent substrate.

16. The optical assembly according to claim 15 wherein said transparent substrate is in contact with said primary lens.

17. The optical assembly according to claim 1 wherein said transparent substrate has a textured surfaces and said primary lens and said transparent substrate have indices of refraction that differ by no more than 0.2.

18. The optical assembly according to claim 17 wherein said indices of refraction differ by no more than 0.1.

19. The optical assembly according to claim 17 wherein said indices of refraction differ by no more than 0.05.

20. An optical assembly comprising:
a circuit board;
an LED mounted on the printed circuit board;
a metal reflector including a mounting portion;
a surface mount reflow solderable mounting device soldered to said circuit board said surface mount reflow solderable mounting device having an engaging portion engaged with said mounting portion of said metal reflector.
